(19) United States
(12) Patent Application Publication
(10) Pub. No.: US 2016/0083532 A1
(43) Pub. Date: Mar. 24, 2016

(54) SUPERABSORBENT POLYMER PRODUCTION USING CERTAIN CARRIERS

(71) Applicant: EVONIK DEGUSSA GMBH, Essen (DE)

(72) Inventors: Dirk Wagner, Tonisvorst (DE); Thomas Hoefges, Baton Rouge, LA (US); Udo Klapperich, Leubsdorf/Rhein (DE); Manfred van Stiphoudt, Kempen (DE); Henry Rudolph, Krefeld (DE); Frank Soppe, Geldern (DE); Jörg Harren, Baesweiler (DE); Franck Furno, Al-Jasra (BH); Frank Loeker, Krefeld (DE)

(73) Assignee: Evonik Degussa GmbH

(21) Appl. No.: 14/861,526

(22) Filed: Sep. 22, 2015

Related U.S. Application Data
(60) Provisional application No. 62/053,960, filed on Sep. 23, 2014.

(30) Foreign Application Priority Data
Sep. 23, 2014 (EP) 14185893.6

(51) Int. Cl. C08J 3/24; C09J 133/02; C08J 5/18; C08J 9/12; D01F 6/36

(52) U.S. Cl. CPC C08J 3/245; C08J 9/122; D01F 6/36; C08J 5/18; C09J 133/02; C08J 2333/02

(57) ABSTRACT

A process is described for production of superabsorbents, comprising conveying steps for transporting the particulate material obtained, with use of a conveying machine from the group of the mechanical continuous conveyors with traction means in at least one of the conveying steps. Conveying machines used with preference are tubular drag conveyors and/or bucket conveyors.

The present invention is in the field of water-absorbing polymer particles. It relates especially to a process for producing the water-absorbing polymer particles using conveying machines from the group of the mechanical continuous conveyors.

In the development of water-absorbing surface crosslinked polymer particles, it is fundamentally desirable to achieve a maximum swelling capacity on contact with liquid, in order to be able to absorb a maximum amount of liquid. In addition, another fundamental aim is adequate gel strength. In this context, it is not only important that the polymer can retain liquid under subsequent application of a pressure, after which the polymer can swell freely. It is also particularly important that the water-absorbing surface crosslinked polymer particles are able to absorb liquids even under a pressure exerted at the same time, as occurs in practice. Optimal liquid absorption has to be assured even when, for example, a baby or person is sitting or lying on a sanitary article or when shear forces are developed, for example through leg movement.

This specific absorption capacity is referred to as absorbency against pressure or AAP for short and can be determined by Edana method ERT 442.2-02 (ERT=Edana Recommended Test; EDANA=European Disposables and Nonwovens Association). The AAP value reported for water-absorbing surface crosslinked polymer particles is determined to a crucial degree by the pressure expended, e.g. 4.83 kPa. In the production of water-absorbing surface crosslinked polymer particles, it is therefore always a worthwhile aim to achieve a very good AAP value.

The specific problem addressed by this invention was therefore to enable the provision of water-absorbing surface crosslinked polymer particles with a very good AAP value, the AAP value being determined as absorbency against a pressure of 4.83 kPa by EDANA (European Disposables and Nonwovens Association) recommended test method no. 442.2-02 “Absorption under pressure”.

It has been found in the context of this invention that, surprisingly, the AAP value can be distinctly impaired by conveying processes during and after the production of the water-absorbing polymer particles.

It has been found that, surprisingly, conveying steps prior to the surface crosslinking step and especially after the surface crosslinking, for example including the conveying step into the end product silos, can have significant influence on the AAP value of the water-absorbing polymer particles, to the effect that the AAP value can be impaired.

It has been found that, surprisingly, the use of particular conveying machines in these conveying steps can assure the provision of water-absorbing polymer particles with a very good AAP value, since impairment of the AAP value can be prevented in this way. These conveying machines are from the group of the mechanical continuous conveyors, preferably mechanical continuous conveyors with traction mechanism, especially tubular drag conveyors and bucket conveyors.

The invention therefore provides a process for producing water-absorbing surface crosslinked polymer particles comprising

(i) the polymerization of a monomer solution or suspension comprising
a) at least one ethylenically unsaturated monomer which bears acid groups and may have been at least partly neutralized,
b) at least one crosslinker,
c) at least one initiator,
d) optionally one or more ethylenically unsaturated monomers copolymerizable with the monomers mentioned in a) and
e) optionally one or more water-soluble polymers,
in order to form a water-insoluble polymer gel,
(ii) optionally comminuting the polymer gel,
(iia) optionally breaking up the polymer gel in a breakup unit which is preferably a rotating drum,
(iii) drying the polymer gel,
(iv) grinding the polymer gel to polymer particles,
(v) classifying the polymer particles,
(vi) surface postcrosslinking the classified polymer particles,
(vii) cooling and optionally aftertreating the surface crosslinked polymer, the process comprising conveying steps for the particulate material that arises, wherein a conveying machine from the group of the mechanical continuous conveyors with traction mechanism is used in at least one of the conveying steps, especially for vertical conveying.

This enables the provision of water-absorbing surface crosslinked polymer particles with a very good AAP value. In contrast, for example, the use of pneumatic conveyors can surprisingly lead to an impairment in the AAP with an otherwise identical process regime.

As well as the particularly important advantage that the AAP is not impaired, the present invention is associated with further advantages. Thus, the particle size distribution is not adversely affected by the process according to the invention, whereas, for example, adverse effects on particle size distribution can be observed especially in the case of pneumatic conveying. The permeability (especially SFC) and gel bed permeability (especially GBP) of the water-absorbing surface crosslinked polymer particles that are the result of the invention are not adversely affected. The formation of dusts and the discharge thereof into the environment can be minimized. Overall, the waste air stream can be significantly reduced, for example, compared to the use of pneumatic conveying means.

Conveying means from the group of mechanical continuous conveyors with traction mechanism are known per se. A particularly preferred conveying machine from the group of mechanical continuous conveyors with traction mechanism that are usable in the context of this invention is the bucket conveyor.

The bucket conveyor and the way it works are known per se and the known, commercially available bucket conveyors may be employed in the context of this invention. A bucket conveyor is a conveying machine which is used especially for the vertical conveying of bulk material, but can also be used for the horizontal conveying of bulk material and for the combination of vertical and horizontal conveying.

Vertical conveying in the context of this invention is a conveying operation which overcomes a difference in height, especially a difference in height of at least one meter, preferably of at least two meters. An upper limit may be 25 meters, for example, or 10 meters, for example, or 5 meters, for example.

What are called bucket elevators have buckets secured in a rigid manner on the traction mechanism; they convey over steep (e.g. angle of slope ≧70°) or vertical displacements. Pendulum bucket conveyors, in turn, have buckets suspended in an articulated manner on the traction mechanism, such that horizontal conveying routes are also possible. Pendulum bucket conveyors thus enable the connection of horizontal and vertical conveying routes. Especially in the cases where a chain is used rather than a belt and the buckets are mounted so as to be movable, it is thus also possible to traverse inclined or horizontal conveying routes.

In a bucket conveyor, vessels made, for example, of steel or plastic are generally secured on a traction mechanism (especially a double or central traction mechanism, for example a section of chain, a chain of joints or a belt (belt bucket conveyor)), and these vessels are generally loaded continuously with material (for example via chutes or analogous devices), convey it (generally upward) in the vessels (e.g. troughs or buckets) on the chains or the belt, and tip it out at the destination, i.e. preferably beyond the upper tail station, for example onto an unloading chute.

A bucket elevator typically has an upper station (preferably with a drive axle, motor and gearbox) and a lower tail station. In a bucket elevator, the material being conveyed is generally introduced at the lower tail station and is generally released at the upper tail station by tipping.

In a pendulum bucket conveyor, the introduction of material can be introduced especially at any desired point in the horizontal conveying route. The material can be released at any point in the horizontal conveying route. To empty them, the buckets preferably run against a stop, as a result of which they are tipped and emptied.

Bucket conveyors may have an open or closed design. More particularly, it is advantageous for the bucket conveyor in the context of this invention to have a closed design and preferably to be operated at minimal reduced pressure through connection to a suction system, which relates to a preferred embodiment of this invention, in order to minimize any dust nuisance. The conveying speed should preferably not exceed 1 m/s.

The minimum bucket speed, especially in the case of a bucket elevator, is related to the weight of the material being conveyed, since the centrifugal force should preferably be sufficient to expel the material at the upper tail pulley. The optimal bucket speed can be ascertained by the person skilled in the art directly by a few exploratory tests in a very simple manner. Especially in the case of a bucket speed of >5 m/s, the material being transported can be expelled. Preferably, through special construction of the bucket, the product leaving the bucket can slide over the back of the bucket in front into the outflow chute, as a result of which a bucket speed of less than 1 m/s can advantageously also be achieved without soiling the bucket interior.

It is also advantageous that the setting of the mass flow rate of bulk material to be conveyed does not require any complex control and regulation technology because the bulk material can be regulated in a simple manner via the drive motor speed and the associated speed at which the belt advances (or speed at which the chain advances) or by means of the amount of bulk material fed to the loading chute.

Bucket conveyors are commercially available. Manufacturers of bucket conveyors in Germany are, for example, the companies Zuther in Karwitz, RUD Ketten in Aalen, Aumund in Rheinberg, Emde Industrietechnik with sites in Nassau an der Lahn and in Wurzen (Saxony), Beumer in Beckum (Westphalia) and DHT in Ennigerloh (Westphalia).

Bucket elevators and/or pendulum bucket conveyors are conveying machines that are very particularly preferred in accordance with the invention from the group of mechanical continuous conveyors with traction mechanism which are usable in the context of this invention.

In the context of this invention, it is also possible, and corresponds to a preferred embodiment, to combine a bucket elevator with a screw conveyor in order thus to achieve, for example, a combination of vertical and horizontal conveying.

Screw conveyors and the way they work are known per se and the known, commercially available screw conveyors may be employed in the context of this invention. These consist essentially of a closed, stationary tube or semicircular trough as carrier unit and a rotating conveying screw, which is the sole moving part, as propulsion unit. Further assemblies in a screw conveyor are especially the material introduction and material release points, the drive unit and, if required, temporary stores.

The conveying screw is typically configured as a shaft with a continuous screw winding secured thereon—for example made of continuously rolled steel ribbon or made of cut and drawn sheet metal blanks. As a modification to this standard design which is usually used, the conveying screw can, for example, also be designed with a double winding, conical winding or winding with variable screw pitch.

A further particularly preferred conveying machine from the group of the continuous conveyors with traction mechanism that are usable in the context of this invention is also the tubular drag conveyor.

Tubular drag conveyors and the way they work are known per se and the known, commercially available tubular drag conveyors may be employed in the context of this invention. With the tubular drug conveyor, horizontal, vertical or diagonal (and also mutually combinable) conveying is possible.

The tubular drag conveyor is basically composed of three essential components, namely a tube as carrier means, a chain with backup and entrainment disks as traction mechanism secured thereto, and a drive station. The basic principle of the tubular drag conveyor is based on movement of a chain with secured backup and entrainment disks or transport disks in a tube.

The chain moves as a continuous traction mechanism within the tube. If the chain is not tensioned of its own accord (for example as a result of gravity), it is additionally necessary to install a tensioning station. In the case of deflections in the line of conveying (for example horizontal to vertical), deflecting stations are used.

Conveying by means of a tubular drive conveyor preferably proceeds in such a way that, at the start, the bulk material to be conveyed is introduced into the conveying pipeline at an intake. Subsequently, the bulk material is entrained in the conveying direction by the transport disks secured on the driven chain and ultimately released again at the end of the conveying route, preferably beneath the drive station, at the outlet.

To adjust the mass flow rate of bulk material, it is merely necessary to regulate the chain drive speed or supply of bulk material. The setting of a suitable mass flow rate of bulk material can be undertaken with the aid of a few exploratory tests.

Tubular drag conveyors are commercially available. Examples include Schrage Rohrkettensystem GmbH; Germany and Horstkotter GmbH & Co. KG, Germany.

In a particularly preferred embodiment of the invention, the conveying of the polymer particles in the context of the process according to the invention is effected using both bucket conveyors, preferably bucket elevators and/or pendulum bucket conveyors, and tubular drag conveyors.

In a further preferred embodiment of the invention, the conveying of the polymer particles in the context of the process according to the invention is effected using both bucket conveyors, preferably bucket elevators and/or pendulum bucket conveyors, and tubular drag conveyors, and also conveying screw(s).

A preferred embodiment of the invention involves a process for producing water-absorbing surface crosslinked polymer particles comprising, in process step (i), the polymerization of a monomer solution or suspension comprising
(a1) 0.1% to 99.999% by weight, preferably 10% to 98.99% by weight, more preferably 15% to 70% by weight, further preferably 20% to 60% by weight, especially 25% to 50% by weight, of ethylenically unsaturated monomer which bears acid groups and may have been at least partly neutralized,
(b1) 0.001% to 10% by weight, preferably 0.01% to 7% by weight, more preferably 0.03% to 5% by weight, especially 0.05% to 2% by weight, of one or more crosslinkers,
(c) at least one initiator,
(d1) 0% to 70% by weight, preferably 0.01% to 40% by weight, more preferably 0.1% to 20% by weight, especially 0.5% to 10% by weight, of ethylenically unsaturated monomers copolymerizable with the monomers mentioned in (a1),
(e1) 0% to 30% by weight, preferably 0.1% to 20% by weight and more preferably 0.5% to 10% by weight of water-soluble polymers, and
(f) 0% to 30% by weight, preferably 0.01% to 7% by weight and more preferably 0.05% to 5% by weight of one or more auxiliaries, where the sum total of the aforementioned weights (a1) to (f) is 100% by weight,
   in order to form a water-insoluble polymer gel.

In a preferred embodiment of the invention, conveying machines from the group of the mechanical continuous conveyors with traction mechanism are used in at least one of the conveying steps (a), (b), preferably at least in a conveying step (b), especially in both conveying steps (a), (b), where the conveying step (a) precedes the surface postcrosslinking step (vi) and the conveying step (b) follows the surface postcrosslinking step (vi), where the conveying steps (a) and/or (b) especially comprise vertical conveying steps. Vertical conveying steps serve to overcome differences in height, preferably of at least one meter, especially at least two meters. An upper limit may be 25 meters, for example, or 10 meters, for example, or 5 meters, for example.

Especially when conveying machines from the group of the mechanical continuous conveyors with retraction mechanism are employed in the conveying, especially comprising vertical conveying, of the already surfaced postcrosslinked polymer particles, the provision of water-absorbing surface crosslinked polymer particles with a very good AAP value can be enabled.

It has been found that the finished end product, i.e. the water-absorbing surface crosslinked polymer particles, can still be subject to an impairment of the AAP value, depending on how the conveying steps for this end product into the end product silo or silo vehicles are configured. If the inventive use of conveying machines from the group of the mechanical continuous conveyors with traction mechanism is implemented at the same time, the provision of water-absorbing surface crosslinked polymer particles with a very good AAP value can be enabled to an even better degree.

In a further preferred embodiment of the invention, conveying machines from the group of the mechanical continuous conveyors with traction mechanism are used in the conveying step (c), especially comprising vertical conveying, where the conveying step (c) relates to the transport of the finished end product, i.e. of the water-absorbing surface crosslinked polymer particles, that is to say the transport into the end product silos or silo vehicles. The conveying step (c) therefore does not precede step (vii), i.e. the optional aftertreatment and/or cooling of the surface crosslinked polymer.

In addition, in a preferred embodiment of the invention, at least conveying step (b), preferably at least conveying steps (b) and (c), advantageously at least conveying steps (a), (b) and (c), especially all the conveying steps, especially comprising vertical conveying, are effected in the process according to the invention using conveying machines from the group of the mechanical continuous conveyors with traction mechanism.

More particularly, in a very particularly preferred embodiment of the invention, conveying machines used in the process according to the invention from step (vi) onward are essentially tubular drag conveyors and/or bucket conveyors, especially for the vertical conveying, and pneumatic conveying measures are essentially dispensed with. Advantageously, a screw conveyor can additionally be used in at least one of the conveying steps. “Essentially using tubular drag conveyors and/or bucket conveyors” means here that at least >50%, preferably >60%, advantageously >70%, further advantageously >80%, even further advantageously >85%, yet more advantageously >90% and especially >95%, for example 100%, of the transport distance (especially the vertical transport distance) to be covered is accomplished with bucket conveyors and/or tubular drag conveyors.

“Essentially dispensing with pneumatic conveying measures” means here that at least >50%, preferably >60%, advantageously >70%, further advantageously >80%, even further advantageously >85%, yet more advantageously >90% and especially >95%, for example 100%, of the transport distance (especially the vertical transport distance) to be covered is accomplished without the aid of pneumatic conveying technology.

It has been found in the context of this invention that the inventive use of the conveying machines is found to be of outstanding utility and leads to particularly good results especially when a blowing agent is used in the polymerization of the monomer solution or suspension. In this way, a foamed water-insoluble polymer gel can be formed. Foamed polymer gel is known per se. Foamed polymer gel may be the result, for example, in the case that gas bubbles are present in the reaction mixture in the polymerization. The patent literature describes various methods for obtaining foamed polymer gel. More particularly, foamed polymer gel comprises small gaseous bubbles enclosed by solid or liquid walls, especially solid walls.

The blowing agents may already be present in the monomer solution or suspension prior to the polymerization and/or may be added to the polymerizing mixture during the polymerization.

In principle, the use of blowing agents in the context of this invention serves to be able to provide foamed water-insoluble polymer gel, in order thus preferably to arrive at polymer particles having elevated porosity and increased surface area. The use of blowing agents in the production of water-absorbing surface crosslinked polymer particles is known per se.

Blowing agents in the context of this invention refer to anything which can serve to produce foams. For production of foams, for example, a gas can be blown into the liquid monomer solution or suspension, or formation of foam is achieved by vigorous beating, agitation, spraying or stirring of the liquid, such as the liquid monomer solution or suspension here. In addition, formation of foam may be based on chemical reactions which proceed with evolution of gas, i.e. result, for example, from the presence of compounds which release gases (for example N2 or CO2), for example under the influence of heat and/or in the presence of water.

In a preferred embodiment of the invention, the blowing agent used is a gas, such as preferably N2 or CO2, especially CO2, or a compound having the ability to release gas, such as carbonate salts in particular.

The compound having the ability to release gas, such as preferably carbonate salts, especially sodium carbonate, can be used in solid form or else in dissolved form, for example in aqueous solution. It can be added to the monomer solution or suspension before or during the polymerization.

Blowing agents used may especially be all carbonates from the group of lithium carbonate, sodium carbonate, potassium carbonate, rubidium carbonate, cesium carbonate, or higher-valency metal ions such as beryllium carbonate, calcium carbonate, magnesium carbonate, strontium carbonate or mixtures thereof. Further compounds used may also be granulated carbonates, which can also be produced as mixed salts of a carbonate and/or percarbonate with a further salt which functions as an outer layer, for example a sulfate compound. According to the invention, the blowing agents may especially have a particle size of 10 μm to 900 μm, preferably 50 μm to 500 μm and more preferably 100 μm to 450 μm.

In the case of addition of blowing agents, for example sodium carbonate, small bubbles are formed or are present. According to the invention, when blowing agents are used, it is therefore also advantageous to use surfactants in order to stabilize these small bubbles. The use of surfactants in combination with the blowing agent therefore enables access to a particularly advantageous fine-pore structure. Surfactants can of course also be used independently of the use of blowing agent.

In addition, in a preferred embodiment of the invention, the monomer solution or suspension thus comprises at least one surfactant.

The surfactant may especially be a nonionic, ionic or amphoteric surfactant, and it is also possible to use surfactant mixtures.

Surfactants are known per se to those skilled in the art. Surfactants usable in accordance with the invention are especially those interface-active compounds which can lower the surface tension of water, preferably below 70 mN/m, more preferably below 68 mN/m, very preferably below 67 mN/m, in each case measured at 23° C. as a 0.103% by weight solution in water.

More particularly, the surfactant is one that has at least one polymerizable group and can thus be polymerized into the resulting polymer as well in the course of polymerization of the monomer solution or suspension. It is preferably an ethylenically unsaturated surfactant. Suitable ethylenically unsaturated groups are, for example, allyl ether, vinyl ether, acrylic ester and methacrylic ester groups.

More particularly, the surfactant has at least one terminal carbon-carbon double bond.

Surfactants usable with preference have at least the following structural element:

CH₂═CH—CH₂—O—(CH₂—CH₂—O)ₙ—

where n is 2 to 20, preferably 4 to 12 and especially 5 to 8.

Further surfactants usable with preference have at least the following structural element:

CH₂═CH—CH₂—O-(EO)ₙ—(PO)ₘ—

with EO=ethylene oxide structural element and
n=0 to 25, advantageously 2 to 20, preferably 4 to 12 and especially 5 to 8,
PO=propylene oxide structural element and
m=0 to 25, advantageously 2 to 20, preferably 3 to 12 and especially 4 to 7,
where the EO and PO units, if present, may be in mixed form or in blockwise or random distribution.

Further surfactants usable with preference have at least the following structural element:

CH2═CR¹—CO—O-(EO)ₙ—(PO)ₘ—

with R¹=hydrogen, methyl or ethyl, preferably methyl or ethyl, most preferably methyl,
EO=ethylene oxide structural element and
n=0 to 25, advantageously 2 to 20, preferably 4 to 12 and especially 5 to 8,
PO=propylene oxide structural element and
m=0 to 25, advantageously 2 to 20, preferably 3 to 12 and especially 4 to 7,
where the EO and PO units, if present, may be in mixed form or in blockwise or random distribution.

Surfactants usable with preference satisfy, for example, the following formula:

CH₂═CH—CH₂—O—(CH₂—CH₂—O)ₙ—Z

where n is 2 to 20, preferably 4 to 12 and especially 5 to 8,
Z=a nonionic end group, for example acetyl-, alkyl-, —OH, ethylenically unsaturated group (for example allyl ether, vinyl ether, acrylic ester and methacrylic ester group)
or else an ionic end group, for example quaternary amine, phosphate or sulfate group,
or satisfy, for example, the following formula:

CH2═CH—CH2-O-(EO)n-(PO)m-Z

with EO=ethylene oxide structural element and
n=2 to 20, preferably 4 to 12 and especially 5 to 8,
PO=propylene oxide structural element and
m=0 to 25, advantageously 2 to 20, preferably 3 to 12 and especially 4 to 7,
where the EO and PO units, if present, may be in mixed form or in blockwise or random distribution,
Z=a nonionic end group, for example acetyl-, alkyl-, —OH, ethylenically unsaturated group (for example allyl ether, vinyl ether, acrylic ester and methacrylic ester group)
or else an ionic end group, for example quaternary amine, phosphate or sulfate group,
or satisfy, for example, the following formula:

CH₂═CR¹—CO—O-(EO)ₙ—(PO)ₘ—Z

with R¹=hydrogen, methyl or ethyl, preferably methyl or ethyl, most preferably methyl,
EO=ethylene oxide structural element and
n=2 to 20, preferably 4 to 12 and especially 5 to 8,
PO=propylene oxide structural element and
m=0 to 25, advantageously 2 to 20, preferably 3 to 12 and especially 4 to 7,
where the EO and PO units, if present, may be in mixed form or in blockwise or random distribution,
Z=a nonionic end group, for example acetyl-, alkyl-, —OH, ethylenically unsaturated group (for example allyl ether, vinyl ether, acrylic ester and methacrylic ester group)
or else an ionic end group, for example quaternary amine, phosphate or sulfate group.

Surfactants usable with preference are also described in patent application WO 2013/072268 A1, which is hereby incorporated by reference. The surfactants mentioned therein are also usable in the context of this invention.

Preferably, the surfactant is present in the monomer solution or suspension in an amount of >0.001% by weight, advantageously 0.01% to 5% by weight, preferably 0.015% to 2% by weight, further preferably 0.02% to 1% by weight, especially 0.02% to 0.5% by weight. In the nomenclature of this invention, the surfactant should preferably be included among the so-called auxiliaries (f).

According to the invention, as a result of the addition of blowing agents before and/or during step (i), i.e. the polymerization, a preferably fine porous structure is achieved and it is thus possible to obtain especially polymer particles having a relatively high surface area. In this way, it is possible to assure quicker absorption of the liquid compared to conventional water-absorbing surface crosslinked polymer particles. This is reflected by the FSR value (FSR=free swell rate). The free swell rate=FSR is determined by the test method described in EPO443627 A2 on page 12, lines 22 to 44.

Water-absorbing polymer particles preferred in accordance with the invention have an FSR in the range from preferably 0.15 to 0.65 and more preferably 0.2 to 0.50 g/gs. According to the invention, it is especially preferable when the FSR value is greater than 0.25 g/gs.

By virtue of the inventive conveying steps, the achievement of the best possible FSR values can be assured, whereas a reduction in the FSR values is probable as a result of pneumatic conveying in particular.

Hydrogels having a high gel strength in the swollen state exhibit good transport properties for liquids. Elevated gel strength is generally achieved through a relatively high level of crosslinking, but this reduces the absorption capacity of the product. A standard method of increasing gel strength is to increase the level of crosslinking at the surface of the superabsorbent particles compared to the interior of the particles. For this purpose, superabsorbent particles which have usually been dried in a surface postcrosslinking step are subjected to additional crosslinking operation in the surface layer of their particles. This corresponds to surface crosslinking. This surface postcrosslinking or surface crosslinking increases the crosslinking density in the shell of the superabsorbent particles, which can raise absorbency against pressure to a higher level.

It has been found in the context of this invention that particularly the improvement in absorbency against pressure which is achievable through the surface postcrosslinking can in turn be impaired by the use of pneumatic conveying, but is not impaired by the use of the inventive conveying, especially comprising vertical conveying.

It is therefore especially preferable in the context of the present invention, after the surface postcrosslinking in step (vi), to very substantially dispense with pneumatic conveying measures, especially in the case of vertical conveying, and instead to very substantially employ mechanical continuous conveyors, especially in the case of vertical conveying. More particularly, it is preferable to essentially dispense with pneumatic conveying measures after the surface postcrosslinking and instead to entirely employ mechanical continuous conveyors with traction mechanism, especially in the case of vertical conveying. In this way, it is possible to achieve the best possible AAP values with otherwise unchanged processes.

“Essentially dispensing with pneumatic conveying measures” means here that at least >50%, preferably >60%, advantageously >70%, further advantageously >80%, even further advantageously >85%, yet more advantageously >90% and especially >95%, e.g. 100%, of the transport distance, especially the vertical transport distance, to be covered is accomplished without the aid of pneumatic conveying technology.

“Essentially completely employing mechanical continuous conveyors” means here that at least >50%, preferably >60%, advantageously >70%, further advantageously >80%, even further advantageously >85%, yet more advantageously >90% and especially >95%, e.g. 100%, of the transport distance, especially the vertical transport distance, to be covered is accomplished with the aid of mechanical continuous conveyors with traction mechanism.

Some preferred possible configurations of the process according to the invention will be described in more detail hereinafter.

The ethylenically unsaturated monomers (a) bearing acid groups may have been partly or fully neutralized, preferably partly neutralized. The ethylenically unsaturated monomers containing acid groups have preferably been neutralized to an extent of at least 10 mol %, more preferably to an extent of at least 25 to 50 mol % and further preferably to an extent of 50 to 90 mol %. The neutralization of the monomers may precede or else follow the polymerization. In this case, for example, the partial neutralization is effected to an extent of at least 10 mol %, more preferably to an extent of at least 25 to 50 mol % and further preferably to an extent of 50-90 mol %. Neutralization can be effected, for example, with alkali metal hydroxides, alkaline earth metal hydroxides, ammonia, and carbonates and bicarbonates. In addition, any further base which forms a water-soluble salt with the acid is conceivable. Mixed neutralization with different bases is also conceivable. Preference is given to neutralization with ammonia or with alkali metal hydroxides, more preferably with sodium hydroxide or with ammonia.

Moreover, the free acid groups in a polymer may predominate, such that this polymer has a pH within the acidic range. This acidic water-absorbing polymer may be at least partly neutralized by a polymer with free basic groups, preferably amine groups, which is basic compared to the acid polymer. These polymers are referred to in the literature as “Mixed-Bed Ion-Exchange Absorbent Polymers” (MBIEA polymers) and are disclosed in WO 99/34843 inter alia. The disclosure of WO 99/34843 is hereby incorporated by reference and is thus considered to form part of the disclosure. In general, MBIEA polymers constitute a composition which includes firstly basic polymers capable of exchanging anions, and secondly a polymer which is acidic compared to the basic polymer and is capable of exchanging cations. The basic polymer has basic groups and is typically obtained by the polymerization of monomers which bear basic groups or groups which can be converted to basic groups. These monomers are in particular those which have primary, secondary or tertiary amines or the corresponding phosphines, or at least two of the above functional groups. This group of monomers includes especially ethyleneamine, allylamine, diallylamine, 4-aminobutene, alkyloxycyclines, vinylformamide, 5-aminopentene, carbodiimide, formaldacine, melamine and the like, and the secondary or tertiary amine derivatives thereof.

Preferred ethylenically unsaturated monomers (a) containing acid groups are acrylic acid, methacrylic acid, ethacrylic acid, α-chloroacrylic acid, α-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, β-stearyl acid, itaconic acid, citraconic acid, mesaconic acid, glutaconic acid, aconitic acid, maleic acid, fumaric acid, tricarboxyethylene and maleic anhydride, preference being given particularly to acrylic acid and methacrylic acid and additionally to acrylic acid.

In addition to these monomers containing carboxylate groups, preferred ethylenically unsaturated monomers (a) containing acid groups additionally include ethylenically unsaturated sulfonic acid monomers or ethylenically unsaturated phosphonic acid monomers.

Ethylenically unsaturated sulfonic acid monomers usable with preference are allylsulfonic acid or aliphatic or aromatic vinylsulfonic acids or acrylic or methacrylic sulfonic acids. Preferred aliphatic or aromatic vinylsulfonic acids are vinylsulfonic acid, 4-vinylbenzylsulfonic acid, vinyltoluenesulfonic acid and styrenesulfonic acid. Preferred acryloyl- or methacryloylsulfonic acids are sulfoethyl (meth)acrylate, sulfopropyl (meth)acrylate, 2-hydroxy-3-methacryloyloxypropylsulfonic acid, and (meth)acrylamidoalkylsulfonic acids such as 2-acrylamido-2-methylpropanesulfonic acid.

Preferred ethylenically unsaturated phosphonic acid monomers are vinylphosphonic acid, allylphosphonic acid, vinylbenzylphosphonic acid, (meth)acrylamidoalkylphosphonic acids, acrylamidoalkyldiphosphonic acids, phosphonomethylated vinylamines and (meth)acryloylphosphonic acid derivatives.

Also usable in the context of this invention are ethylenically unsaturated monomers containing a protonated nitrogen. Preferred ethylenically unsaturated monomers containing a protonated nitrogen are preferably dialkylaminoalkyl (meth)acrylates in protonated form, for example dimethylaminoethyl (meth)acrylate hydrochloride or dimethylamino ethyl (meth)acrylate hydrosulfate, and dialkylaminoalkyl(meth)acrylamides in protonated form, for example dimethylaminoethyl(meth)acrylamide hydrochloride, dimethylaminopropyl(meth)acrylamide hydrochloride, dimethylaminopropyl(meth)acrylamide hydrosulfate or dimethylaminoethyl(meth)acrylamide hydrosulfate.

Also usable in the context of this invention are ethylenically unsaturated monomers containing a quaternized nitrogen. Preferred ethylenically unsaturated monomers containing a quaternized nitrogen are dialkylammonioalkyl (meth)acrylates in quaternized form, for example trimethylammonioethyl (meth)acrylate methosulfate or dimethylethylammonioethyl (meth)acrylate ethosulfate, and (meth)acrylamidoalkyldialkylamines in quaternized form, for example (meth)acrylamidopropyltrimethylammonium chloride, trimethylammonioethyl (meth)acrylate chloride or (meth)acrylamidopropyltrimethylammonium sulfate.

Preferred ethylenically unsaturated monomers (d) copolymerizable with the aforementioned monomers (a) containing acid groups are especially acrylamides and methacrylamides, the use of the monomers (d) being merely optional.

Preferred (meth)acrylamides are, in addition to acrylamide and methacrylamide, alkyl-substituted (meth)acrylamides or aminoalkyl-substituted derivatives of (meth)acrylamide, such as N-methylol(meth)acrylamide, N,N-dimethylamino(meth)acrylamide, dimethyl(meth)acrylamide or diethyl(meth)acrylamide. Possible vinylamides are, for example, N-vinylamides, N-vinylformamides, N-vinylacetamides, N-vinyl-N-methylacetamides, N-vinyl-N-methylformamides, vinylpyrrolidone. Among these monomers, particular preference is given to acrylamide.

Additionally preferred as ethylenically unsaturated monomers (d) copolymerizable with (a) are water-dispersible monomers. Preferred water-dispersible monomers are acrylic esters and methacrylic esters, such as methyl (meth)acrylate, ethyl (meth)acrylate, propyl (meth)acrylate or butyl (meth)acrylate, and also vinyl acetate, styrene and isobutylene.

Crosslinkers (b) preferred in accordance with the invention are compounds having at least two ethylenically unsaturated groups within one molecule (crosslinker class I), compounds having at least two functional groups which can react with functional groups of monomers (a) or (d) in a condensation reaction (=condensation crosslinkers), in an addition reaction or in a ring-opening reaction (crosslinker class II), compounds which have at least one ethylenically unsaturated group and at least one functional group which can react with functional groups of monomers (a) or (d) in a condensation reaction, in an addition reaction or in a ring-opening reaction (crosslinker class III), or polyvalent metal cations (crosslinker class IV). The compounds of crosslinker class I achieve crosslinking of the polymers through the free-radical polymerization of the ethylenically unsaturated groups of the crosslinker molecule with the ethylenically unsaturated monomers (a) or (d), while the compounds of crosslinker class II and the polyvalent metal cations of crosslinker class IV achieve crosslinking of the polymers by a condensation reaction of the functional groups (crosslinker class II) or by electrostatic interaction of the polyvalent metal cation (crosslinker class IV) with the functional groups of monomers (a) or (d). In the case of the compounds of crosslinker class III, there is correspondingly crosslinking of the polymer both by free-radical polymerization of the ethylenically unsaturated group and by a condensation reaction between the functional group of the crosslinker and the functional groups of monomers (a) or (d).

Preferred compounds of crosslinker class I are poly(meth)acrylic esters which are obtained, for example, by the reaction of a polyol, for example ethylene glycol, propylene glycol, trimethylolpropane, 1,6-hexanediol, glycerol, pentaerythritol, polyethylene glycol or polypropylene glycol, of an amino alcohol, of a polyalkylenepolyamine, for example diethylenetriamine or triethylenetetramine, or of an alkoxylated polyol with acrylic acid or methacrylic acid. Preferred compounds of crosslinker class I are additionally polyvinyl compounds, poly(meth)allyl compounds, (meth)acrylic esters of a monovinyl compound or (meth)acrylic esters of a mono(meth)allyl compound, preferably of the mono(meth)allyl compounds of a polyol or of an amino alcohol. In this context, reference is made to DE 195 43 366 and DE 195 43 368. The disclosures are hereby incorporated by reference and are thus considered to form part of the disclosure.

Examples of compounds of crosslinker class I include alkenyl di(meth)acrylates, for example ethylene glycol di(meth)acrylate, 1,3-propylene glycol di(meth)acrylate, 1,4-butylene glycol di(meth)acrylate, 1,3-butylene glycol di(meth)acrylate, 1,6-hexanediol di(meth)acrylate, 1,10-decanediol di(meth)acrylate, 1,12-dodecanediol di(meth)acrylate, 1,18-octadecanediol di(meth)acrylate, cyclopentanediol di(meth)acrylate, neopentyl glycol di(meth)acrylate, methylene di(meth)acrylate or pentaerythritol di(meth)acrylate, alkenyldi(meth)acrylamides, for example N-methyldi(meth)acrylamide, N,N′-3-methylbutylidenebis(meth)acrylamide, N,N′-(1,2-dihydroxyethylene)bis(meth)acrylamide, N,N′-hexamethylenebis(meth)acrylacrylamide or N,N′-methylenebis(meth)acrylamide, polyalkoxy di(meth)acrylates, for example diethylene glycol di(meth)acrylate, triethylene glycol di(meth)acrylate, tetraethylene glycol di(meth)acrylate, dipropylene glycol di(meth)acrylate, tripropylene glycol di(meth)acrylate or tetrapropylene glycol di(meth)acrylate, bisphenol A di(meth)acrylate, ethoxylated bisphenol A di(meth)acrylate, benzylidene di(meth)acrylate, 1,3-di(meth)acryloyloxy-2-propanol, hydroquinone di(meth)acrylate, di(meth)acrylate esters of trimethylolpropane which has preferably been alkoxylated, preferably ethoxylated, with 1 to 30 mol of alkylene oxide per hydroxyl group, thioethylene glycol di(meth)acrylate, thiopropylene glycol di(meth)acrylate, thiopolyethylene glycol di(meth)acrylate, thiopolypropylene glycol di(meth)acrylate, divinyl ethers, for example 1,4-butanediol divinyl ether, divinyl esters, for example divinyl adipate, alkanedienes, for example butadiene or 1,6-hexadiene, divinylbenzene, di(meth)allyl compounds, for example di(meth)allyl phthalate or di(meth)allyl succinate, homo- and copolymers of di(meth)allyldimethylammonium chloride and homo- and copolymers of diethyl(meth)allylaminomethyl (meth)acrylate ammonium chloride, vinyl (meth)acryloyl compounds, for example vinyl (meth)acrylate, (meth)allyl (meth)acryloyl compounds, for example (meth)allyl (meth)acrylate, (meth)allyl (meth)acrylate ethoxylated with 1 to 30 mol of ethylene oxide per hydroxyl group, di(meth)allyl esters of polycarboxylic acids, for example di(meth)allyl maleate, di(meth)allyl fumarate, di(meth)allyl succinate or di(meth)allyl terephthalate, compounds having 3 or more ethylenically unsaturated, free-radically polymerizable groups, for example glyceryl tri(meth)acrylate, (meth)acrylate esters of glycerol which has been ethoxylated with preferably 1 to 30 mol of ethylene oxide per hydroxyl group, trimethylolpropane tri(meth)acrylate, tri(meth)acrylate esters of trimethylolpropane which has preferably been alkoxylated, preferably ethoxylated, with 1 to 30 mol of alkylene oxide per hydroxyl group, trimethacrylamide, (meth)allylidene di(meth)acrylate, 3-allyloxy-1,2-propanediol di(meth)acrylate, ti(meth)allyl cyanurate, ti(meth)allyl isocyanurate, pentaerythritol tetra(meth)acrylate, pentaerythritol tri(meth)acrylate, (meth)acrylic esters of pentaerythritol ethoxylated with preferably 1 to 30 mol of ethylene oxide per hydroxyl group, tris(2-hydroxyethyl) isocyanurate tri(meth)acrylate, trivinyl trimellitate, tri(meth)allylamine, di(meth)allylalkylamines, for example di(meth)allylmethylamine, ti(meth)allyl phosphate, tetra(meth)allylethylenediamine, poly(meth)allyl esters, tetra(meth)allyloxyethane or tetra(meth)allylammonium halides.

Preferred compounds of crosslinker class II are compounds which have at least two functional groups which can react in a condensation reaction (=condensation crosslinkers), in an addition reaction or in a ring-opening reaction with the functional groups of monomers (a) or (d), preferably with acid groups of monomers (a). These functional groups of the compounds of crosslinker class II are preferably alcohol, amine, aldehyde, glycidyl, isocyanate, carbonate or epichloro functions.

Examples of compounds of crosslinker class II include polyols, for example ethylene glycol, polyethylene glycols such as diethylene glycol, triethylene glycol and tetraethylene glycol, propylene glycol, polypropylene glycols such as dipropylene glycol, tripropylene glycol or tetrapropylene glycol, 1,3-butanediol, 1,4-butanediol, 1,5-pentanediol, 2,4-pentanediol, 1,6-hexanediol, 2,5-hexanediol, glycerol, polyglycerol, trimethylolpropane, polyoxypropylene, oxyethylene-oxypropylene block copolymers, sorbitan fatty acid esters, polyoxyethylene sorbitan fatty acid esters, pentaerythritol, polyvinyl alcohol and sorbitol, amino alcohols, for example ethanolamine, diethanolamine, triethanolamine or propanolamine, polyamine compounds, for example ethylenediamine, diethylenetriamine, triethylenetetramine, tetraethylenepentamine or pentaethylenehexamine, polyglycidyl ether compounds such as ethylene glycol diglycidyl ether, polyethylene glycol diglycidyl ether, glyceryl diglycidyl ether, glyceryl polyglycidyl ether, pentaerythrityl polyglycidyl ether, propylene glycol diglycidyl ether, polypropylene glycol diglycidyl ether, neopentyl glycol diglycidyl ether, hexanediol glycidyl ether, trimethylolpropane polyglycidyl ether, sorbitol polyglycidyl ether, diglycidyl phthalate, adipic acid diglycidyl ether, 1,4-phenylenebis(2-oxazoline), glycidol, polyisocyanates, preferably diisocyanates such as toluene 2,4-diisocyanate and hexamethylene diisocyanate, polyaziridine compounds such as 2,2-bishydroxymethylbutanol tris[3-(1-aziridinyl)propionate], 1,6-hexamethylenediethyleneurea and diphenylmethanebis-4,4′-N,N′-diethyleneurea, halogen peroxides, for example epichloro- and epibromohydrin and α-methylepichlorohydrin, alkylene carbonates such as 1,3-dioxolan-2-one (ethylene carbonate), 4-methyl-1,3-dioxolan-2-one (propylene carbonate), 4,5-dimethyl-1,3-dioxolan-2-one, 4,4-dimethyl-1,3-dioxolan-2-one, 4-ethyl-1,3-dioxolan-2-one, 4-hydroxymethyl-1,3-dioxolan-2-one, 1,3-dioxan-2-one, 4-methyl-1,3-dioxan-2-one, 4,6-dimethyl-1,3-dioxan-2-one, 1,3-dioxolan-2-one, poly-1,3-dioxolan-2-one, polyquaternary amines such as condensation products of dimethylamines and epichlorohydrin. Preferred compounds of crosslinker class II are additionally polyoxazolines such as 1,2-ethylenebisoxazoline, crosslinkers with silane groups, such as γ-glycidoxypropyltrimethoxysilane and γ-aminopropyltrimethoxysilane, oxazolidinones such as 2-oxazolidinone, bis- and poly-2-oxazolidinones and diglycol silicates.

Preferred compounds of class III include hydroxyl- or amino-containing esters of (meth)acrylic acid, for example 2-hydroxyethyl (meth)acrylate and 2-hydroxypropyl (meth)acrylate, and also hydroxyl- or amino-containing (meth)acrylamides or mono(meth)allyl compounds of diols.

The polyvalent metal cations of crosslinker class IV derive preferably from mono- or polyvalent cations, the monovalent especially from alkali metals such as potassium, sodium, lithium, preference being given to lithium. Preferred divalent cations derive from zinc, beryllium, alkaline earth metals such as magnesium, calcium, strontium, preference being given to magnesium. Further higher-valency cations usable in accordance with the invention are cations of aluminum, iron, chromium, manganese, titanium, zirconium and other transition metals, and also double salts of such cations or mixtures of the salts mentioned. Preference is given to using aluminum salts and alums and the different hydrates thereof, for example AlCl₃×6H₂O, NaAl(SO₄)₂×12 H₂O, KAl(SO₄)₂×12 H₂O or Al₂(SO₄)₃×14-18H₂O. Particular preference is given to using Al₂(SO₄)₃ and hydrates thereof as crosslinkers of crosslinking class IV.

The superabsorbent particles obtainable in the process according to the invention (these are the water-absorbing polymer particles that result as the process end product of the process according to the invention) are preferably crosslinked by crosslinkers of the following crosslinker classes or by crosslinkers of the following combinations of crosslinker classes: I, II, III, IV; III; I III; I IV; I II III; I II IV; I III IV; II III IV; II IV or III IV. The above combinations of crosslinker classes are each a preferred embodiment in the context of the invention.

The use of crosslinkers of crosslinker class I is particularly preferred. Among these, preference is given to water-soluble crosslinkers. In this context, particular preference is given to N,N′-methylenebisacrylamide, polyethylene glycol di(meth)acrylates, triallylmethylammonium chloride, tetraallylammonium chloride, and allyl nonaethylene glycol acrylate prepared with 9 mol of ethylene oxide per mole of acrylic acid.

Optional water-soluble polymers (e) used may be water-soluble polymers, such as partly or fully hydrolyzed polyvinyl alcohol, polyvinylpyrrolidone, starch or starch derivatives, polyglycols or polyacrylic acid. The molecular weight of these polymers is uncritical provided that they are water-soluble. Preferred water-soluble polymers are starch or starch derivatives or polyvinyl alcohol. The water-soluble polymers, preferably synthetic water-soluble polymers such as polyvinyl alcohol, can also serve as a graft base for the monomers to be polymerized.

Assistants (f) used may, for example, be organic or inorganic particles, for example odor binders, especially zeolites or cyclodextrins, skincare substances, surfactants or antioxidants. Auxiliaries in the context of this invention may also be surfactants, which are usable together with blowing agents in particular.

The preferred organic auxiliaries include cyclodextrins or derivatives thereof, and polysaccharides. Also preferred are cellulose and cellulose derivatives such as CMC, cellulose ethers. Preferred cyclodextrins or cyclodextrin derivatives are those compounds disclosed in DE-A-198 25 486 at page 3 line 51 to page 4 line 61. The aforementioned section of this published patent application is hereby incorporated by reference and is considered to form part of the disclosure of the present invention. Particularly preferred cyclodextrins are underivatized α-, β-, γ- or δ-cyclodextrins.

Inorganic particulate auxiliaries used may be any materials which are typically used to modify the properties of water-absorbing polymers. The preferred inorganic auxiliaries include sulfates such as Na₂SO₄, lactates, for instance sodium lactate, silicates, especially framework silicates such as zeolites, or silicates which have been obtained by drying aqueous silica solutions or silica sols, for example the commercially available products such as precipitated silicas and fumed silicas, for example Aerosils having a particle size in the range from 5 to 50 nm, preferably in the range from 8 to 20 nm, such as “Aerosil 200” from Evonik Industries AG, aluminates, titanium dioxides, zinc oxides, clay materials, and further minerals familiar to those skilled in the art, and also carbonaceous inorganic materials.

Preferred silicates include any natural or synthetic silicates disclosed as silicates in Hollemann and Wiberg, Lehrbuch der Anorganischen Chemie, Walter de Gruyter-Verlag, 91st-100th. edition, 1985, on pages 750 to 783. The aforementioned section of this textbook is hereby incorporated by reference and is considered to form part of the disclosure of the present invention.

Particularly preferred silicates are the zeolites. The zeolites used may be all synthetic or natural zeolites known to those skilled in the art. Preferred natural zeolites are zeolites from the natrolite group, the harmotone group, the mordenite group, the chabasite group, the faujasite group (sodalite group) or the analcite group. Examples of natural zeolites are analcime, leucite, pollucite, wairakite, bellbergite, bikitaite, boggsite, brewsterite, chabasite, willhendersonite, cowlesite, dachiardite, edingtonite, epistilbite, erionite, faujasite, ferrierite, amicite, garronite, gismondine, gobbinsite, gmelinite, gonnardite, goosecreekite, harmotone, phillipsite, wellsite, clinoptilolite, heulandite, laumontite, levyne, mazzite, merlinoite, montesommaite, mordenite, mesolite, natrolite, scolecite, offretite, paranatrolite, paulingite, perlialite, barrerite, stilbite, stellerite, thomsonite, tschernichite or yugawaralite. Preferred synthetic zeolites are zeolite A, zeolite X, zeolite Y, zeolite P, or the product ABSCENTS®.

The zeolites used may be zeolites of what is called the “intermediate” type, in which the SiO₂/AlO₂ ratio is less than 10; the SiO₂/AlO₂ ratio of these zeolites is more preferably within a range from 2 to 10. In addition to these “intermediate” zeolites, it is also possible to use zeolites of the “high” type, which include, for example, the known “molecular sieve” zeolites of the ZSM type, and β-zeolite. These “high” zeolites are preferably characterized by an SiO₂/AlO₂ ratio of at least 35, more preferably by an SiO₂/AlO₂ ratio within a range from 200 to 500.

The aluminates used are preferably the naturally occurring spinels, especially common spinel, zinc spinel, iron spinel or chromium spinel.

Preferred titanium dioxide is pure titanium dioxide in the rutile, anatase and brookite crystal forms, and also iron-containing titanium dioxides, for example ilmenite, calcium-containing titanium dioxides such as titanite or perovskite.

Preferred clay materials are those which are disclosed as clay materials in Hollemann and Wiberg, Lehrbuch der Anorganischen Chemie, Walter de Gruyter-Verlag, 91st-100th. edition, 1985, on pages 783 to 785. Particularly the aforementioned section of this textbook is hereby incorporated by reference and is considered to form part of the disclosure of the present invention. Particularly preferred clay materials are kaolinite, illite, halloysite, montmorillonite and talc.

Further inorganic fines preferred in accordance with the invention are the metal salts of the mono-, oligo- and polyphosphoric acids. Among these, preference is given especially to the hydrates, particular preference being given to the mono- to decahydrates and trihydrates. Useful metals include especially alkali metals and alkaline earth metals, preference being given to the alkaline earth metals. Among these, Mg and Ca are preferred and Mg is particularly preferred. In the context of phosphates, phosphoric acids and metal compounds thereof, reference is made to Hollemann and Wiberg, Lehrbuch der Anorganischen Chemie, Walter de Gruyter-Verlag, 91^{st}-100^{th} edition, 1985, on pages 651 to 669. The aforementioned section of this textbook is hereby incorporated by reference and is considered to form part of the disclosure of the present invention.

Preferred carbonaceous but nonorganic assistants are those pure carbons which are mentioned as graphites in Hollemann and Wiberg, Lehrbuch der Anorganischen Chemie, Walter de Gruyter-Verlag, 91st-100th edition, 1985, on pages 705 to 708. The aforementioned section of this textbook is hereby incorporated by reference and is considered to form part of the disclosure of the present invention. Particularly preferred graphites are synthetic graphites, for example coke, pyrographite, activated carbon or carbon black.

It is optionally possible to add any known chelating agents as auxiliaries to the monomer solution or suspension or to the raw materials thereof for better control of the polymerization reaction. Suitable chelating agents are, for example, phosphoric acid, diphosphoric acid, triphosphoric acid, polyphosphoric acid, citric acid, tartaric acid, and salts thereof.

Additionally suitable as auxiliaries are, for example, iminodiacetic acid, hydroxyethyliminodiacetic acid, nitrilotriacetic acid, nitrilotripropionic acid, ethylenediaminetetraacetic acid, diethylenetriaminepentaacetic acid, triethylenetetraminehexaacetic acid, N,N-bis(2-hydroxyethyl)glycine and trans-1,2-diaminocyclohexanetetraacetic acid, and salts thereof. The amount used is typically 1 to 30,000 ppm, based on the total amount of monomer, preferably 10 to 1,000 ppm, preferably 20 to 600 ppm, more preferably 50 to 400 ppm, most preferably 100 to 300 ppm.

The water-absorbing polymers obtained in the process according to the invention are preferably obtainable by first preparing a polymer gel, also called a hydrogel polymer, in particulate form from the aforementioned monomers and crosslinkers. This starting material for the water-absorbing polymers can be produced, for example, by bulk polymerization which is preferably effected in kneading reactors such as extruders, solution polymerization, spray polymerization, inverse emulsion polymerization or inverse suspension polymerization. Preferably, the solution polymerization can be performed in water as solvent. Solution polymerization can be effected continuously or batchwise. The prior art discloses a wide spectrum of possible variations with regard to reaction conditions, such as temperatures, type and amount of the initiators, and to the reaction solution. Typical processes are described in the following patents: U.S. Pat. No. 4,286,082, DE 27 06 135, U.S. Pat. No. 4,076,663, DE 35 03 458, DE 40 20 780, DE 42 44 548, DE 43 23 001, DE 43 33 056, DE 44 18 818. The disclosures are hereby incorporated by reference and are thus considered to form part of the disclosure.

Initiators (c) used to initiate the polymerization may be any initiators which form free radicals under the polymerization conditions and are typically used in the production of superabsorbents. These include thermal initiators, redox initiators and photoinitiators, which are activated by means of high-energy radiation. The polymerization initiators may be present dissolved or dispersed in a solution of inventive monomers. Preference is given to the use of water-soluble initiators.

Useful thermal initiators include all compounds which decompose to free radicals when heated and are known to those skilled in the art. Particular preference is given to thermal polymerization initiators having a half-life of less than 10 seconds, further preferably of less than 5 seconds at less than 180° C., further preferably at less than 140° C. Peroxides, hydroperoxides, hydrogen peroxide, persulfates and azo compounds are particularly preferred thermal polymerization initiators. In some cases, it is advantageous to use mixtures of different thermal polymerization initiators. Among these mixtures, preference is given to those of hydrogen peroxide and sodium peroxodisulfate or potassium peroxodisulfate, which can be used in any conceivable ratio. Suitable organic peroxides are preferably acetylacetone peroxide, methyl ethyl ketone peroxide, benzoyl peroxide, lauroyl peroxide, acetyl peroxide, capryl peroxide, isopropyl peroxydicarbonate, 2-ethylhexyl peroxydicarbonate, t-butyl hydroperoxide, cumene hydroperoxide, t-amyl perpivalate, t-butyl perpivalate, t-butyl perneohexoate, t-butyl isobutyrate, t-butyl per-2-ethylhexenoate, t-butyl perisononanoate, t-butyl permaleate, t-butyl perbenzoate, t-butyl 3,5,5-trimethylhexanoate and amyl perneodecanoate. Further preferred thermal polymerization initiators are: azo compounds such as azobisisobutyronitrile, azobisdimethylvaleronitrile, 2,2′-azobis(2-amidinopropane) dihydrochloride, azobisamidinopropane dihydrochloride, 2,2′-azobis(N,N-dimethylene)isobutyramidine dihydrochloride, 2-(carbamoylazo)isobutyronitrile and 4,4′-azobis(4-cyanovaleric acid). The compounds mentioned are used in customary amounts, preferably within a range from 0.01 to 5 mol %, preferably from 0.1 to 2 mol %, based in each case on the amount of the monomers to be polymerized.

The redox initiators comprise, as the oxidic component, at least one of the above-specified per compounds, and, as the reducing component, preferably ascorbic acid, glucose, sorbose, mannose, ammonium hydrogensulfite, sulfate, thiosulfate, hyposulfite or sulfide, alkali metal hydrogensulfite, sulfate, thiosulfate, hyposulfite or sulfide, metal salts such as iron(II) ions or silver ions, or sodium hydroxymethylsulfoxylate. The reducing component used in the redox initiator is preferably ascorbic acid or sodium pyrosulfite. Based on the amount of monomers used in the polymerization, for example, 1×10⁻⁵ to 1 mol % of the reducing component of the redox initiator and, for example, 1×10⁻⁵ to 5 mol % of the oxidizing component of the redox initiator are used. Instead of the oxidizing component of the redox initiator, or in addition thereto, it is possible to use one or more, preferably water-soluble, azo compounds.

If the polymerization is triggered by the action of high-energy radiation, it is customary to use what are called photoinitiators as the initiator. These may be, for example, what are called α-splitters, H-abstracting systems, or else azides. Examples of such initiators are benzophenone derivatives such as Michler's ketone, phenanthrene derivatives, fluorene derivatives, anthraquinone derivatives, thioxanthone derivatives, coumarin derivatives, benzoin ethers and derivatives thereof, azo compounds such as the abovementioned free-radical formers, substituted hexaarylbisimidazoles or acylphosphine oxides. Examples of azides are: 2-(N,N-dimethylamino)ethyl 4-azidocinnamate, 2-(N,N-dimethylamino)ethyl 4-azidonaphthyl ketone, 2-(N,N-dimethylamino)ethyl 4-azidobenzoate, 5-azido-1-naphthyl 2′-(N,N-dimethylamino)ethyl sulfone, N-(4-sulfonylazidophenyl)maleimide, N-acetyl-4-sulfonylazidoaniline, 4-sulfonylazidoaniline, 4-azidoaniline, 4-azidophenacyl bromide, p-azidobenzoic acid, 2,6-bis(p-azidobenzylidene)cyclohexanone and 2,6-bis(p-azidobenzylidene)-4-methylcyclohexanone. If they are used, the photoinitiators are employed typically in amounts of 0.01 to 5% by weight, based on the monomers to be polymerized.

Preference is given in accordance with the invention to using an initiator system consisting of hydrogen peroxide, sodium peroxodisulfate and ascorbic acid. In general, the polymerization is initiated with the initiators within a temperature range from 0° C. to 90° C.

The polymerization reaction can be triggered by one initiator or by a plurality of interacting initiators. In addition, the polymerization can be performed in such a way that one or more redox initiators are first added. Later in the polymerization, thermal initiators or photoinitiators are then applied additionally, and the polymerization reaction in the case of photoinitiators is then initiated by the action of high-energy radiation. The reverse sequence, i.e. the initial initiation of the reaction by means of high-energy radiation and photoinitiators or thermal initiators and initiation of the polymerization by means of one or more redox initiators later in the polymerization, is also conceivable.

In order to convert the polymer gel which is the result of the polymerization and is also referred to as hydrogel polymer to a particulate form, after it has been separated out of the reaction mixture, it can first optionally be comminuted, for example in an extruder or kneader or by grinding in comminution units designed like a meat grinder, corresponding to step (ii), then optionally broken up, corresponding to step (iia), and then dried, corresponding to step (iii).

The optional commination in step (ii) can especially be performed with a comminuting unit which preferably comprises a cutting unit, a tearing unit and/or a grinding unit. With the aid of the cutting unit, the polymer gel is cut. With the aid of the tearing unit, the polymer gel is torn up. With the aid of the grinding unit, the polymer gel is crushed. Through a combination of these three modes of commination, particularly advantageous commination can be achieved.

A commination step (ii) is advantageous especially when the monomer solution or suspension is polymerized with the aid of a belt reactor. In the kneading reactor, the polymer gel which forms in the polymerization of an aqueous monomer solution or suspension is comminuted continuously, for example by means of contra-rotating stirrer shafts actually within the kneader itself.

In the optional breakup in step (iia), the polymer gel is broken up with a suitable breakup unit. Advantageously, the breakup unit is a rotating drum, preferably a drum rotation mixer. The breakup can reduce the bulk material density of the polymer gel.

In a preferred embodiment, both the comminution step (ii) and the breakup step (iia) are implemented.

During the drying of the polymer gel in step (iii), the latter preferably having been comminuted and broken up beforehand in the optional steps (ii) and (iia), the water content of the polymer gel is reduced. Drying can be effected, for example, at a temperature within a range from 20 to 300° C., preferably within a range from 50 to 250° C. and more preferably within a range from 100 to 200° C., down to a water content of, for example, less than 40% by weight, preferably of less than 20% by weight and further preferably of less than 10% by weight, for example 2% to 8% by weight, based in each case on the total weight of the polymer gel, the residual moisture content being determinable by EDANA recommended test method ERT 430.2-02. The drying is effected preferably in ovens or driers known to those skilled in the art, for example in belt driers, staged driers, rotary tube ovens, fluidized bed driers, pan driers, paddle driers or infrared driers. The EDANA test methods are obtainable, for example, from EDANA, Avenue Eugene Plasky 157, B-1030 Brussels, Belgium.

In the case of too high a residual moisture content, the dried polymer gel has too low a glass transition temperature Tg and can be processed further only with difficulty. In the case of too low a residual moisture content, the dried polymer gel is too brittle and, in the subsequent comminution steps, undesirably large amounts of polymer particles with too low a particle size (“fines”) are obtained. The solids content of the gel prior to drying is preferably from 25% and 90% by weight, more preferably from 35% to 70% by weight, most preferably from 40% to 60% by weight.

Thereafter, the dried polymer gel is ground, corresponding to step (iv), and classified, corresponding to step (v), it being possible to use the standard apparatuses for grinding, such as typically one-stage or multistage roll mills, preferably two- or three-stage roll mills, pinned disk mills, hammer mills or vibratory mills.

Classifying can be executed in a known manner, as is customary in superabsorbent production, preference being given especially to screen classifying. Screen classifying comprises the separation of the particulate material according to its geometric dimensions with the aid of a separating surface (screen plate) having defined orifices. The separating surfaces may have different designs: for example grids, perforated plates, wire mesh. The sieving process is especially executed with relative movement between the material being screened and the screen plate.

The median particle size of the polymer particles separated off as product fraction is preferably at least 150 μm, more preferably from 150 to 800 μm, very particularly from 200 to 750 μm. The median particle size of the product fraction can be determined by means of EDANA recommended test method ERT 420.2-02 “Partikel Size Distribution”, the proportions by mass of the screen fractions being plotted cumulatively and the median particle size being determined by means of a graph. The median particle size here is the mesh size value at which a cumulative 50% by weight is found. Preference is given to using dried water-absorbing polymer particles having a water content of less than 10% by weight, preferably of less than 5% by weight, more preferably of less than 3% by weight. The water content can be determined, for example, by EDANA (European Disposables and Nonwovens Association) recommended test method No. 430.2-02 “Moisture content”.

The proportion of particles having a particle size of at least 150 μm is preferably at least 90% by weight, more preferably at least 95% by weight, most preferably at least 98% by weight.

Polymer particles having too low a particle size lower the permeability (SFC). Therefore, the proportion of excessively small polymer particles (“fines”) should be small. Excessively small polymer particles are therefore typically separated off and recycled into the process. This is preferably done before, during or immediately after the polymerization, i.e. before the drying of the polymer gel. The excessively small polymer particles can be moistened with water and/or aqueous surfactant before or during the recycling.

It is also possible to separate off excessively small polymer particles in later process steps, for example after the surface postcrosslinking or another coating step.

The proportion of particles having a particle size of at most 850 μm is preferably at least 90% by weight, more preferably at least 95% by weight, most preferably at least 98% by weight. The proportion of particles having a particle size of at most 750 μm is preferably at least 90% by weight, more preferably at least 95% by weight, most preferably at least 98% by weight.

Polymer particles having too high a particle size lower the free swell rate. Therefore, the proportion of excessively large polymer particles should likewise be small.

Excessively large polymer particles are therefore typically separated off and recycled into the grinding of the dried polymer gel.

To further improve the properties, the polymer particles can be surfaced postcrosslinked, especially with supply of heat, corresponding to step (vii).

In a preferred embodiment of the processes according to the invention, the water-absorbing polymers obtained are particles having an inner region and a surface region bordering the inner region. The surface region has a different chemical composition from the inner region, or differs from the inner region in a physical property. Physical properties in which the inner region differs from the surface region are, for example, the charge density or the degree of crosslinking. These water-absorbing polymers having an inner region and a surface region bordering the inner region are preferably obtainable by postcrosslinking reactive groups close to the surface of the particles of the polymer. This surface crosslinking or surface postcrosslinking can be effected by thermal, photochemical or chemical means, especially by thermal means.

Preferred postcrosslinkers are the compounds of crosslinker classes II and IV mentioned in connection with the abovementioned crosslinkers (b).

Among these compounds, particularly preferred postcrosslinkers are diethylene glycol, triethylene glycol, polyethylene glycol, glycerol, polyglycerol, propylene glycol, diethanolamine, triethanolamine, polyoxypropylene, oxyethylene-oxypropylene block copolymers, sorbitan fatty acid esters, polyoxyethylenesorbitan fatty acid esters, trimethylolpropane, pentaerythritol, polyvinyl alcohol, sorbitol, 1,3-dioxolan-2-one (ethylene carbonate), 4-methyl-1,3-dioxolan-2-one (propylene carbonate), 4,5-dimethyl-1,3-dioxolan-2-one, 4,4-dimethyl-1,3-dioxolan-2-one, 4-ethyl-1,3-dioxolan-2-one, 4-hydroxymethyl-1,3-dioxolan-2-one, 1,3-dioxan-2-one, 4-methyl-1,3-dioxan-2-one, 4,6-dimethyl-1,3-dioxan-2-one, 1,3-dioxolan-2-one, poly-1,3-dioxolan-2-one.

Particular preference is given to using ethylene carbonate as the postcrosslinker.

Preferred embodiments of the water-absorbing polymers are those which are postcrosslinked by crosslinkers of the following crosslinker classes or by crosslinkers of the following combinations of crosslinker classes: II; IV; II IV.

The postcrosslinker is preferably used in an amount of >0.001% by weight, advantageously within a range from 0.01 to 30% by weight, more preferably in an amount within a range from 0.1% to 20% by weight, further preferably in an amount within a range from 0.2% to 5% by weight, especially 0.3% to 2% by weight, based in each case on the weight of the superabsorbent polymers in the postcrosslinking.

It is likewise preferable that the postcrosslinking is effected by contacting a solvent comprising preferably water, water-miscible organic solvents, for instance methanol or ethanol or mixtures of at least two thereof, and the postcrosslinker with the outer region of the polymer particles at a temperature within a range from 30 to 300° C., more preferably within a range from 100 to 200° C.

The contacting is preferably effected by spraying the mixture comprising postcrosslinker and solvent onto the hydrogel polymer particles and then mixing the hydrogel polymer particles contacted with the mixture. The postcrosslinker is present in the mixture preferably in an amount of >0.001% by weight, advantageously within a range from 0.01% to 70% by weight, more preferably in an amount within a range from 0.1% to 60% by weight, for example in amounts of 30% to 50% by weight, based on the total weight of the mixture.

Useful condensation reactions preferably include the formation of ester, amide, imide or urethane bonds, preference being given to the formation of ester bonds.

It is especially preferable when, before, during or after the surface postcrosslinking, in addition to other surface postcrosslinkers, polyvalent cations, corresponding to crosslinker class IV, are applied to the particle surface, the amount of polyvalent cation used being, for example, 0.001% to 3% by weight, preferably 0.005% to 2% by weight, more preferably 0.02% to 1% by weight, based in each case on the polymer particles.

In a preferred embodiment of the invention, the surface postcrosslinking is especially performed in such a way that a solution of the surface postcrosslinker is sprayed onto the dried polymer particles. After the spray application, the polymer particles coated with surface postcrosslinker are preferably dried thermally, and the surface postcrosslinking reaction may take place either before or during the drying.

The spray application of a solution of the surface postcrosslinker can preferably be performed in mixers with moving mixing tools, such as screw mixers, disk mixers and paddle mixers. Particular preference is given to horizontal mixers such as paddle mixers, very particular preference to vertical mixers. The distinction between horizontal mixers and vertical mixers is made by the position of the mixing shaft, i.e. horizontal mixers have a horizontally mounted mixing shaft and vertical mixers have a vertically mounted mixing shaft. Suitable mixers are, for example, horizontal Pflugschar® plowshare mixers (Gebr. Lodige Maschinenbau GmbH; Paderborn; Germany), Vrieco-Nauta continuous mixers (Hosokawa Micron BV; Doetinchem; the Netherlands), Processall Mixmill mixers (Processall Incorporated; Cincinnati; USA) and Schugi Flexomix® (Hosokawa Micron BV; Doetinchem; the Netherlands). However, it is also possible to spray on the surface postcrosslinker solution in a fluidized bed. The surface postcrosslinkers can especially be used in aqueous solution. It is possible to adjust the penetration depth of the surface postcrosslinker into the polymer particles via the content of nonaqueous solvent or total amount of solvent.

It is possible with preference to use solvent mixtures, for example isopropanol/water, propane-1,3-diol/water and propylene glycol/water, where the mixing ratio is preferably from 20:80 to 40:60.

The thermal drying can preferably be performed in contact driers, more preferably paddle driers, most preferably disk driers. Suitable driers are, for example, Hosokawa Bepex® Horizontal Paddle Dryers (Hosokawa Micron GmbH; Leingarten; Germany), Hosokawa Bepex® Disc Dryers (Hosokawa Micron GmbH; Leingarten; Germany), Holo-Flite® driers (Metso Minerals Industries Inc.; Danville; USA) and Nara Paddle Dryers (NARA Machinery Europe; Frechen; Germany). Moreover, fluidized bed driers may also be used.

The drying can be effected in the mixer itself, by heating the jacket or blowing in warm air. Equally suitable is a downstream drier, for example a shelf drier, a rotary tube oven or a heatable screw. It is particularly advantageous to effect mixing and drying in a fluidized bed drier. Preferred drying temperatures are in the range of 100 to 250° C., preferably 120 to 220° C., more preferably 130 to 210° C. and most preferably 150 to 200° C. The preferred residence time at this temperature in the reaction mixer or drier is preferably at least 10 minutes, more preferably at least 20 minutes, most preferably at least 30 minutes, and typically at most 60 minutes.

The aforementioned thermal drying can be effected in the course of step (vi), i.e. of the surface postcrosslinking.

In a preferred embodiment of the present invention, the water-absorbing polymer particles can be cooled and optionally aftertreated after the thermal drying, corresponding to step (vii).

The cooling is preferably performed in contact coolers, more preferably paddle coolers, most preferably disk coolers. Suitable coolers are, for example, Hosokawa Bepex® Horizontal Paddle Coolers (Hosokawa Micron GmbH; Leingarten; Germany), Hosokawa Bepex® Disc Coolers (Hosokawa Micron GmbH; Leingarten; Germany), Holo-Flite® coolers (Metso Minerals Industries Inc.; Danville; USA) and Nara Paddle Coolers (NARA Machinery Europe; Frechen; Germany). Moreover, fluidized bed coolers may also be used.

In the cooler, the water-absorbing polymer particles may be cooled, for example, to 20 to 150° C., preferably 40 to 120° C., more preferably 60 to 100° C. and most preferably 70 to 90° C. During or after cooling, the polymer particles can be aftertreated if desired.

Subsequently, the surface postcrosslinked polymer particles can be classified again, with removal of excessively small and/or excessively large polymer particles and recycling into the process.

To further improve the properties, the surface postcrosslinked polymer particles can optionally be aftertreated, namely, for example, coated or remoisturized. This can be effected, for example, during or after the cooling.

The optional remoisturizing is preferably performed at 30 to 90° C., more preferably at 35 to 70° C., most preferably at 40 to 60° C. At excessively low temperatures, the water-absorbing polymer particles tend to form lumps, and, at higher temperatures, water already evaporates to a noticeable degree. The amount of water used for remoisturizing is preferably from 0.1% to 10% by weight, more preferably from 0.2% to 8% by weight and most preferably from 0.3% to 5% by weight, based in each case on the water-absorbing polymer particles. The remoisturizing increases the mechanical stability of the polymer particles and reduces their tendency to static charging. The remoisturizing is advantageously performed in the cooler after the thermal drying. Suitable coatings for improving the free swell rate and permeability (SFC) are, for example, inorganic inert substances, such as water-insoluble metal salts, organic polymers, cationic polymers and di- or polyvalent metal cations. Suitable coatings for dust binding are, for example, polyols and polyethylene glycols. Suitable coatings for counteracting the undesired caking tendency of the polymer particles are, for example, fumed silica, such as Aerosil® 200, and surfactants, such as Span® 20.

In addition, it is also possible to add further additives and effect substances.

Preferred additives are, for example, release agents, for instance inorganic or organic pulverulent release agents. These release agents can preferably be used in amounts within a range from 0% to 2% by weight, more preferably within a range from 0.1% to 1.5% by weight, based on the weight of the water-absorbing polymer. Preferred release agents are wood flour, pulp fibers, powdered bark, cellulose powder, mineral fillers such as perlite, synthetic fillers such as nylon powder, rayon powder, diatomaceous earth, bentonite, kaolin, zeolites, talc, loam, ash, carbon dust, magnesium silicates, fertilizers or mixtures of the substances. Finely divided fumed silica, as sold under the Aerosil trade name by Evonik Degussa, is preferred.

Effect substances are, for example, polysugars, polyphenolic compounds, for example hydrolyzable tannins or compounds including a silicon-oxygen, or a mixture of at least two effect substances based thereon. The effect substance can be added either in solid form (powder) or in dissolved form with a solvent. In the context of the present invention, an effect substance is especially understood to mean a substance which serves for odor inhibition. According to the invention, this is understood to mean polysugars, by which the person skilled in the art understands those from the group of the familiar starches and derivatives thereof, celluloses and derivatives thereof, cyclodextrins. Cyclodextrins are preferably understood to mean α-cyclodextrin, β-cyclodextrin, γ-cyclodextrin or mixtures of these cyclodextrins.

Preferred compounds containing silicon-oxygen are zeolites. The zeolites used may be all synthetic or natural zeolites known to those skilled in the art. Preferred natural zeolites are zeolites from the natrolite group, the harmotone group, the mordenite group, the chabasite group, the faujasite group (sodalite group) or the analcite group. Examples of natural zeolites are analcime, leucite, pollucite, wairakite, bellbergite, bikitaite, boggsite, brewsterite, chabazite, willhendersonite, cowlesite, dachiardite, edingtonite, epistilbite, erionite, faujasite, ferrierite, amicite, garronite, gismondine, gobbinsite, gmelinite, gonnardite, goosecreekite, harmotome, phillipsite, wellsite, clinoptilolite, heulandite, laumontite, levyne, mazzite, merlinoite, montesommaite, mordenite, mesolite, natrolite, scolecite, offretite, paranatrolite, paulingite, perlialite, barrerite, stilbite, stellerite, thomsonite, tschernichite or yugawaralite. Preferred synthetic zeolites are zeolite A, zeolite X, zeolite Y, zeolite P, or the product ABSCENTS®.

The cations present in the zeolites usable in the process according to the invention are preferably alkali metal cations such as Li⁺, Na⁺, K⁺, Rb⁺, Cs⁺ or Fr⁺ and/or alkaline earth metal cations such as Mg²⁺, Ca²⁺, Sr²⁺ or Ba²⁺.

The zeolites used may be zeolites of what is called the “intermediate” type, in which the SiO₂/AlO₂ ratio is less than 10; the SiO₂/AlO₂ ratio of these zeolites is more preferably within a range from 2 to 10. In addition to these “intermediate” zeolites, it is also possible to use zeolites of the “high” type, which include, for example, the known “molecular sieve” zeolites of the ZSM type, and beta-zeolite. These “high” zeolites are preferably characterized by an SiO₂/AlO₂ ratio of at least 35, more preferably by an SiO₂/AlO₂ ratio within a range from 200 to 500.

The zeolites are preferably used in the form of particles with a mean particle size within a range from 1 to 500 μm, more preferably within a range from 2 to 200 μm and further preferably within a range from 5 to 100 μm.

The effect substances can be used in the process according to the invention preferably in an amount within a range from 0.1 to 50% by weight, more preferably within a range from 1 to 40% by weight and further preferably in an amount within a range from 5 to 30% by weight, based in each case on the weight of the water-absorbing polymer particles.

Preferred microbe-inhibiting substances are in principle all substances active against Gram-positive bacteria, for example 4-hydroxybenzoic acid and salts and esters thereof, N-(4-chlorophenyl)-N′-(3,4-dichlorophenyl)urea, 2,4,4′-trichloro-2′-hydroxydiphenyl ether (triclosan), 4-chloro-3,5-dimethylphenol, 2,2′-methylenebis(6-bromo-4-chlorophenol), 3-methyl-4-(1-methylethyl)phenol, 2-benzyl-4-chlorophenol, 3-(4-chlorophenoxy)-1,2-propanediol, 3-iodo-2-propynyl butylcarbamate, chlorhexidine, 3,4,4′-trichlorocarbonilide (TTC), antibacterial fragrances, thymol, thyme oil, eugenol, clove oil, menthol, mint oil, famesol, phenoxyethanol, glyceryl monocaprate, glyceryl monocaprylate, glyceryl monolaurate (GML), diglyceryl monocaprate (DMC), N-alkylsalicylamides, for example N-n-octylsalicylamide or N-n-decylsalicylamide.

Suitable enzyme inhibitors are, for example, esterase inhibitors. These are preferably trialkyl citrates such as trimethyl citrate, tripropyl citrate, triisopropyl citrate, tributyl citrate and especially triethyl citrate (Hydagen™ CAT, Cognis GmbH, Dusseldorf, Germany). The substances inhibit enzyme activity and as a result reduce odor formation. Further substances useful as esterase inhibitors are sterol sulfates or phosphates, for example lanosterol sulfate or phosphate, cholesterol sulfate or phosphate, campesterol sulfate or phosphate, stigmasterol sulfate or phosphate and sitosterol sulfate or phosphate, dicarboxylic acids and esters thereof, for example glutaric acid, monoethyl glutarate, diethyl glutarate, adipic acid, monoethyl adipate, diethyl adipate, malonic acid and diethyl malonate, hydroxycarboxylic acids and esters thereof, for example citric acid, malic acid, tartaric acid or diethyl tartrate, and zinc glycinate.

Suitable odor absorbers are substances which can absorb and substantially retain odor-forming compounds. They lower the partial pressure of the individual components and thus also reduce the rate of spread thereof. It is important that perfumes must remain unimpaired. Odor absorbers have no effect against bacteria. They contain, for example, as the main constituent, a complex zinc salt of ricinoleic acid or specific, substantially odor-neutral fragrances known to the person skilled in the art as “fixatives”, for example extracts of labdanum or styrax or particular abietic acid derivatives. The function of odor maskers is fulfilled by odorants or perfume oils which, in addition to their function as odor maskers, impart their particular fragrance note to the deodorants. Examples of perfume oils include mixtures of natural and synthetic odorants. Natural odorants are extracts of flowers, stems and leaves, fruits, fruit skins, roots, woods, herbs and grasses, needles and twigs, and also resins and balsams. Additionally useful are animal raw materials, for example civet and castoreum. Typical synthetic odorant compounds are products of the ester, ether, aldehyde, ketone, alcohol and hydrocarbon type. Odorant compounds of the ester type are, for example, benzyl acetate, p-tert-butylcyclohexyl acetate, linalyl acetate, phenylethyl acetate, linalyl benzoate, benzyl formate, allyl cyclohexylpropionate, styrallyl propionate and benzyl salicylate. The ethers include, for example, benzyl ethyl ether; the aldehydes include, for example, the linear alkanals having 8 to 18 carbon atoms, citral, citronellal, citronellyloxyacetaldehyde, cyclamen aldehyde, hydroxycitronellal, lilial and bourgeonal; the ketones include, for example, the ionones and methyl cedryl ketone; the alcohols include anethole, citronellol, eugenol, isoeugenol, geraniol, linalool, phenylethyl alcohol and terpineol; the hydrocarbons include principally the terpenes and balsams. Preference is given, however, to using mixtures of different odorants which together produce a pleasing fragrance note. Suitable perfume oils are also essential oils of relatively low volatility which are usually used as aroma components, for example sage oil, camomile oil, clove oil, melissa oil, mint oil, cinnamon leaf oil, lime blossom oil, juniper berry oil, vetiver oil, olibanum oil, galbanum oil, labdanum oil and lavender oil. Preference is given to using bergamot oil, dihydromyrcenol, lilial, lyral, citronellol, phenylethyl alcohol, alpha-hexylcinnamaldehyde, geraniol, benzylacetone, cyclamen aldehyde, linalool, Boisambrene Forte, ambroxan, indole, Hedione, Sandelice, lemon oil, mandarin oil, orange oil, allyl amyl glycolate, cyclovertal, lavender oil, clary sage oil, beta-damascone, geranium oil bourbon, cyclohexyl salicylate, Vertofix Coeur, Iso-E-Super, Fixolide NP, Evernyl, iraldein gamma, phenylacetic acid, geranyl acetate, benzyl acetate, rose oxide, Romilat, Irotyl and Floramat, alone or in mixtures.

Antiperspirants reduce the formation of perspiration by influencing the activity of the eccrine sweat glands, and thus counteract underarm wetness and body odor. Suitable astringent active antiperspirant ingredients are in particular salts of aluminum, zirconium or zinc. Suitable antihydrotically active ingredients of this type include, for example, aluminum chloride, aluminum chlorohydrate, aluminum dichlorohydrate, aluminum sesquichlorohydrate and complexed compounds thereof, for example with 1,2-propylene glycol, aluminum hydroxyallantoinate, aluminum chloride tartrate, aluminum zirconium trichlorohydrate, aluminum zirconium tetrachlorohydrate, aluminum zirconium pentachlorohydrate and their complexed compounds, for example with amino acids such as glycine.

Suitable apparatus for mixing or spraying in the context of this invention is in principle any which allows homogeneous distribution of a solution, powder, suspension or dispersion on or with the hydrogel polymer particles or water-absorbing polymers. Examples are Lödige mixers (manufactured by Gebrüder Lödige Maschinenbau GmbH), Gericke multi-flux mixers (manufactured by Gericke GmbH), DRAIS mixers (manufactured by DRAIS GmbH Spezialmaschinenfabrik Mannheim), Hosokawa mixers (Hosokawa Mokron Co., Ltd.), Ruberg mixers (manufactured by Gebr. Ruberg GmbH & Co. KG Nieheim), Hüttlin coaters (manufactured by BWI Hüttlin GmbH Steinen), fluidized bed dryers or spray granulators from AMMAG (manufactured by AMMAG Gunskirchen, Austria) or Heinen (manufactured by A. Heinen AG Anlagenbau Varel), Patterson-Kelly mixers, NARA paddle mixers, screw mixers, pan mixers, fluidized bed dryers or Schugi mixers. For contacting in a fluidized bed, it is possible to employ any fluidized bed processes which are known to those skilled in the art and appear to be suitable. For example, it is possible to use a fluidized bed coater.

According to the invention, it is particularly advantageous to feed the polymer particles that result from the surface crosslinking step, corresponding to step (vi), to the cooling step (vii), i.e. to the cooling apparatus in question, with the aid of a bucket conveyor and/or tubular drag conveyor, especially a bucket conveyor.

According to the invention, it is also particularly advantageous to feed the polymer particles that result from the cooling step, corresponding to step (vii), to the optional aftertreatment step with the aid of a bucket conveyor and/or tubular drag conveyor, especially a bucket conveyor.

The optional aftertreatment after the surface postcrosslinking is preferably performed in suitable mixing units or in contact driers, more preferably paddle driers, most preferably disk driers. Suitable units are, for example, Hosokawa Bepex® Horizontal Paddle Dryers (Hosokawa Micron GmbH; Leingarten; Germany), Hosokawa Bepex® Disc Dryers (Hosokawa Micron GmbH; Leingarten; Germany) and Nara Paddle Dryers (NARA Machinery Europe; Frechen; Germany). Moreover, fluidized bed driers may also be used.

The optional aftertreatment step preferably comprises the treatment of the surface crosslinked polymer particles by
i) contacting (preferably coating) the polymer particles, preferably with at least one salt of a polyvalent metal cation and a non-complexing acid anion,
   and/or with a compound with dedusting capacity, such as preferably polyol or polyethylene glycol,
   and/or with odor-inhibiting and/or odor-reducing substances, preferably tannin-containing aqueous solutions,
   the coating substances preferably each being applied from aqueous solution, especially by spray application,
and/or
ii) increasing the moisture content of the polymer particles, preferably by 1% to 150% by weight, and
iii) optionally drying after the increase in the moisture content.

A “tannin” in the context of the present invention is generally understood to mean naturally occurring polyphenols. In principle, it is possible in accordance with the invention to use what are called “condensed tannins” or else “hydrolyzable tannins”, particular preference being given to the use of hydrolyzable tannins and greatest preference being given to the use of hydrolyzable gallotannins Compounds of this kind are known per se and are described, for example, in German patent application DE102007045724A1, to which reference is hereby made. “Condensed tannins” are preferably understood to mean tannins which are oligomers or polymers of flavonoid units joined together via C—C bonds. Condensed tannins of this kind comprise typically 2 to 50 flavonoid units, but may also consist of more than 50 flavonoid units. Useful flavonoid units especially include catechin and epicatechin. “Hydrolyzable tannins” are preferably understood to mean tannins consisting of a polyol, for example a carbohydrate, as core, with gallic acid bound to the OH groups of this core molecule via ester bonds. Such hydrolyzable tannin based on gallic acid are therefore frequently also referred to as “gallotannins” As well as gallic acid, the hydrolyzable tannins may also be based on ellagic acid. Such hydrolyzable tannins are frequently also referred to as “ellagitannins”.

Subsequently, i.e. after the optional aftertreatment, the surface postcrosslinked and aftertreated polymer particles can be classified again, with removal of excessively small and/or excessively large polymer particles and recycling into the process. The transport, especially comprising vertical conveying, of the surfaced postcrosslinked and optionally aftertreated polymer particles to the screening apparatus for optional reclassifying is preferably achieved with the aid of a bucket conveyor and/or tubular drag conveyor.

Subsequently, i.e. after the optional classifying, the polymer particles can then be transferred into the end product silos or silo vehicles, in which case the transport, especially comprising vertical conveying, of the polymer particles in question into the end product silos or silo vehicles is preferably brought about with the aid of a bucket conveyor and/or tubular drag conveyor, especially with the aid of tubular drag conveyors.

A preferred embodiment of the invention is a process for producing water-absorbing surface crosslinked polymer particles, comprising

(i) the polymerization of a monomer solution or suspension comprising
a) at least one ethylenically unsaturated monomer which bears acid groups and may have been at least partly neutralized,
b) at least one crosslinker,
c) at least one initiator,
d) optionally one or more ethylenically unsaturated monomers copolymerizable with the monomers mentioned in a) and
e) optionally one or more water-soluble polymers,
in order to form a water-insoluble polymer gel,
(ii) comminuting the polymer gel,
(iia) breaking up the polymer gel, preferably in a breakup unit which is especially a rotating drum,
(iii) drying the polymer gel,
(iv) grinding the polymer gel to polymer particles,
(v) classifying the polymer particles,
(vi) surface postcrosslinking the classified polymer particles,
(vii) cooling and aftertreating the surface crosslinked polymer,
(viii) classifying the polymer particles,
the process comprising conveying steps for the particulate material that arises, with employment of essentially bucket conveyors and/or tubular drag conveyors for each conveying operation (especially each vertical conveying operation) of the particulate material after step (vi). In the aforementioned embodiment, especially between steps (vi), (vii) and (viii), essentially bucket conveyors are employed for conveying (especially vertical conveying), and, after step (viii), relating to transport into the end silo, especially comprising vertical conveying, essentially tubular drag conveyors are employed.

“Essentially” means here that at least >50%, preferably >60%, advantageously >70%, further advantageously >80%, even further advantageously >85%, yet more advantageously >90% and especially >95%, e.g. 100%, of the transport distance (especially the vertical transport distance) to be covered is accomplished with bucket conveyors and/or tubular drag conveyors.

More particularly, pneumatic conveying measures are essentially dispensed with, especially in the case of vertical conveying, between steps (vi), (vii) and (viii) and after step (viii).

“Essentially dispensing with pneumatic conveying measures” means here that at least >50%, preferably >60%, advantageously >70%, further advantageously >80%, even further advantageously >85%, yet more advantageously >90% and especially >95%, e.g. 100%, of the transport distance (especially the vertical transport distance) to be covered is accomplished without the aid of pneumatic conveying technology.

A vertical transport route in the context of this invention is a transport route which overcomes a difference in height, especially a difference in height of at least one meter, preferably of at least two meters. An upper limit may be 25 meters, for example, or 10 meters, for example, or 5 meters, for example.

The present invention further provides the water-absorbing polymer particles obtainable by the process according to the invention. These are typically referred to as superabsorbents.

The water-absorbing polymer particles obtainable in accordance with the invention have a centrifuge retention capacity (CRC) of advantageously at least 15 g/g, preferably at least 20 g/g, more preferably at least 22 g/g, especially preferably at least 24 g/g, most preferably at least 26 g/g. A preferred range for the centrifuge retention capacity (CRC) is, for example, between 24-32 g/g. The centrifuge retention capacity (CRC) of the water-absorbing polymer particles is typically less than 60 g/g. Centrifuge retention capacity (CRC) is determined by EDANA (European Disposables and Nonwovens Association) recommended test method No. 441.2-02 “Centrifuge retention capacity”.

The water-absorbing polymer particles obtainable in accordance with the invention have an absorbency against a pressure of 4.83 kPa (corresponding to the AAP value) of advantageously at least 10 g/g, preferably at least 15 g/g, more preferably at least 20 g/g, especially preferably at least 22 g/g, most preferably at least 23 g/g, further preferably at least 24 g/g. The absorbency of the water-absorbing polymer particles against a pressure of 4.83 kPa is typically less than 30 g/g. Absorbency against a pressure of 4.83 kPa is determined by EDANA (European Disposables and Nonwovens Association) recommended test method No. 442.2-02 “Absorption under pressure”. The AAP value in the context of this invention is the absorbency against a pressure of 4.83 kPa, determined by EDANA (European Disposables and Nonwovens Association) recommended test method No. 442.2-02 “Absorption under pressure”.

The water-absorbing polymer particles obtainable in accordance with the invention have a permeability (SFC) of advantageously at least 50×10⁻⁷ cm³ s/g, preferably at least 60×10⁻⁷ cm³ s/g, more preferably at least 70×10⁻⁷ cm³ s/g, especially preferably at least 80×10⁻⁷ cm³ s/g, very especially preferably at least 90×10⁻⁷ cm³ s/g. Permeability (SFC) of the water absorbing polymer particles is typically less than 250×10⁻⁷ cm³ s/g. The permeability (SFC) is determined by the measurement of the “Saline Flow Conductivity-SFC” by the test method described in WO95/26209 A1. The starting weight of the superabsorbent material is 1.5 g rather than 0.9 g. The SFC value in the present invention is always based on 1.5 g of the superabsorbent material.

The gel bed permeability (GBP) of a swollen gel layer can especially be determined under a compressive stress of 0.3 psi (2070 Pa), as described in US 2005/02567575 (paragraphs [0061] and [0075] therein), as the gel bed permeability of a swollen gel layer of water-absorbing polymer particles.

In a preferred embodiment of the invention, the water-absorbing polymer particles obtainable in accordance with the invention have

(a) a centrifuge retention capacity (CRC) of at least 24 g/g,
(b) a free swell rate (FSR) of at least 0.15 g/gs,
(c) a permeability (SFC) of at least 50×10⁻⁷ cm³ s/g,
(d) an absorbency against a pressure of 4.83 kPa of at least 15 g/g,
(e) a surface tension preferably exceeding 50 mN/m.

The surface tension was determined by measurement as per the test method described in EP 1 493 453 A1 at page 12 paragraphs [0105] to [0111], especially using a Kruss K11 tensiometer with a Wilhelmy plate.

In a further preferred embodiment of the invention, the proportion of water-absorbing polymer particles having a particle size of at least 150 μm is at least 90% by weight, more preferably at least 95% by weight, most preferably at least 98% by weight, and the proportion of water-absorbing polymer particles having a particle size of at most 850 μm is preferably at least 90% by weight, more preferably at least 95% by weight, most preferably at least 98% by weight, based in each case on the total amount of the water-absorbing polymer particles.

The present invention further provides hygiene articles comprising water-absorbing polymer particles obtainable in accordance with the invention, especially hygiene articles for feminine hygiene, hygiene articles for light and heavy incontinence, diapers or small animal litter.

The production of the hygiene articles is described in the monograph “Modern Superabsorbent Polymer Technology”, F. L. Buchholz and A. T. Graham, Wiley-VCH, 1998, pages 252 to 258. Also described therein is the production of water-absorbing polymer particles.

The hygiene articles typically contain a water-impervious backsheet, a water-pervious top sheet, and between them an absorbent core composed of the inventive water-absorbing polymer particles and fibers, preferably cellulose. The proportion of the inventive water-absorbing polymer particles in the absorbent core is preferably 20% to 100% by weight, more preferably 50% to 100% by weight.

This invention further provides a composite comprising the water-absorbing polymer particles obtainable in accordance with the invention or the water-absorbing polymer particles obtainable by the processes according to the invention and a substrate. It is preferable that the inventive water-absorbing polymers and the substrate are bonded to one another in a fixed manner. Preferred substrates are films of polymers, for example of polyethylene, polypropylene or polyamide, metals, nonwovens, fluff, tissues, fabrics, natural or synthetic fibres, or foams. It is additionally preferred in accordance with the invention that the composite comprises at least one region which includes water-absorbing polymer particles in an amount in the range from about 15 to 100% by weight, preferably about 30 to 100% by weight, more preferably from about 50 to 99.99% by weight, further preferably from about 60 to 99.99% by weight and even further preferably from about 70 to 99% by weight, based in each case on the total weight of the region of the composite in question, this region preferably having a size of at least 0.01 cm³, preferably at least 0.1 cm³ and most preferably at least 0.5 cm³.

This invention further provides a process for producing a composite, wherein the water-absorbing polymer particles obtainable in accordance with the invention or the superabsorbents obtainable by the process according to the invention and a substrate and optionally an additive are contacted with one another. The substrates used are preferably those substrates which have already been mentioned above in connection with the inventive composite.

This invention further provides a composite obtainable by the process described above, this composite preferably having the same properties as the above-described inventive composite.

This invention further provides chemical products comprising the water-absorbing polymer particles obtainable in accordance with the invention or an inventive composite. Preferred chemical products are especially foams, mouldings, fibres, foils, films, cables, sealing materials, liquid-absorbing hygiene articles, especially diapers and sanitary napkins, carriers for plant growth or fungal growth regulators or plant protection active ingredients, additives for building materials, packaging materials or soil additives.

This invention also provides for the use of the water-absorbing polymer particles obtainable in accordance with the invention or of the inventive composite in chemical products, preferably in the aforementioned chemical products, especially in hygiene articles such as diapers or sanitary napkins, and for the use of the water-absorbing polymer particles as carriers for plant growth or fungal growth regulators or plant protection active ingredients. In the case of use as a carrier for plant growth or fungal growth regulators or plant protection active ingredients, it is preferable that the plant growth or fungal growth regulators or plant protection active ingredients can be released over a period controlled by the carrier.

### Test Methods

Unless stated otherwise, the measurements specified are conducted especially by ERT methods. “ERT” stands for EDANA Recommended Test and “EDANA” for European Disposables and Nonwovens Association. These ERT methods and other test methods have already been specified above. The EDANA test methods are obtainable, for example, from EDANA, Avenue Eugene Plasky 157, B-1030 Brussels, Belgium.

All test methods are in principle, unless stated otherwise, conducted at an ambient temperature of 23±2° C. and a relative air humidity of 50±10%.

The method specified in the context of this invention can be used to characterize the superabsorbents obtained in the process, the process according to the invention in principle having a beneficial effect on all the parties specified, but especially enabling the achievement of particularly good AAP values.

### EXAMPLE

The process according to the invention can in principle be implemented in all existing processes, especially industrial scale processes, for superabsorbent production.

### General Production Process

300 kg of acrylic acid were mixed with 429.1 kg of H₂O, 1.2 kg of allyloxy polyethylene glycol acrylate and 1.2 kg of polyethylene glycol-300 diacrylate, and the mixture was cooled to 10° C. Thereafter, a total of 233.1 kg of 50% sodium hydroxide solution were added while cooling, at a sufficiently slow rate that the temperature did not exceed 30° C. Subsequently, the solution was purged with nitrogen at 20° C. and cooled down further in the process. On attainment of the start temperature of 4° C., the initiator solutions (0.1 kg of 2,2′-azobis-2-amidinopropane dihydrochloride in 10 kg of H₂O; 0.15 kg of sodium peroxydisulfate in 10 kg of H₂O; 0.1 kg of 30% hydrogen peroxide solution in 1 kg of H₂O and 0.01 kg of ascorbic acid in 2 kg of water) were added. The polymerization was conducted on a continuous belt with a residence time of about 40 minutes.

The resultant gel was comminuted and dried at 150-180° C. for 60 minutes. The dried polymer was crushed coarsely, ground and screened continuously to give a powder having a particle size of 150 to 850 μm.

For surface postcrosslinking, this fraction was coated continuously with 2% of a solution of 1 part ethylene carbonate and 1 part water in a mixer and heated to 185° C. in a paddle drier (residence time about 40 min).

The product thus obtained was cooled down and then classified again, and the fraction having a particle size of 150 to 850 μm was regarded as the end product of the process. Each resulting particulate, surface crosslinked end product of the process was then introduced into a silo for storage.

### Conveying Steps

In the above-described production process, conveying steps were necessary; one of these was that the particulate intermediate after the 1st classifying operation had to be conveyed to the surface crosslinking step (corresponding to conveying step a), and another was the final conveying of the particulate surface crosslinked end product into a storage silo (corresponding to conveying step c).

### Variant a

In variant a, in the context of the aforementioned conveying steps a) and c), in accordance with the present invention, tubular drag conveyors were employed in step c) and bucket conveyors in step a). The end product obtained in the storage silo is referred to as end product a.

### Variant b

In variant b, the aforementioned conveying steps were conducted in a customary manner using pneumatic conveying technology. The end product obtained in the storage silo is referred to as end product b. The only difference in the production of end products a and b is thus that different conveying steps have been used in each case, according to the variants a and b just specified.

### Result:

After repeating the respective productions five times each, it was found that the AAP value (more specifically AAP 4.83 kPa) of end product a was 0.9 g/g higher on average than the AAP value of end product b. The process according to the invention thus enables the provision of water-absorbing surface crosslinked polymer particles with a very good AAP value. In contrast to variant b, particle size distribution, permeability (SFC) and gel bed permeability (GBP) were not impaired in variant a.

In another series of experiments, Superabersorbent A, with a CRC of 27.3 g/g, and AAP of 24.7 g/g and a GBP of 19.8 was conveyed after surface crosslinking to a further cooling step. In one experiment it was transported by a bucket conveyor and in a second experiment it was conveyed in a pneumatic process by means of compressed air. The results can be found in Table 1.

Superabsorbent B, with a CRC of 26.2 g/g, an AAP of 25.0 and a GBP of 17.1 was conveyed after surface crosslinking to a further cooling step. In one experiment it was transported by a bucket conveyor and in a second experiment it was conveyed in a pneumatic process by means of compressed air. The results can be found in Table 1.

Superabsorbent C, with a CRC of 32.3 g/g, an AAP of 16.8 and a GBP of 36.4 was conveyed after surface crosslinking and cooling to a storage vessel. In one experiment it was transported by a tubular drag chain conveyor and in a second experiment it was conveyed in a pneumatic process by means of compressed air. The results can be found in Table 1.

Superabsorbent C, with a CRC of 32.8 g/g, an AAP of 18.4 and a GBP of 36.8 was conveyed after surface crosslinking and cooling to a storage vessel. In one experiment it was transported by a tubular drag chain conveyor and in a second experiment it was conveyed in a pneumatic process by means of compressed air. The results can be found in Table 1.

Particle size distributions were determined EDANA test method ERT 420.2-02 for the standard mesh sizes in Table 1.

As can be seen in Table 1, the use of mechanical continuous conveyors with a traction mechanism results in less damage of the superabsorbent, less loss in AAP absorption under pressure and less loss in GBP permeability than pneumatic conveying. It is not uncommon that the pneumatic conveying damage actually increases the CRC by damaging the higher crosslink density surface of the particles, which is important for high performing superabsorbent polymers. A close examination of the particle size distribution of the superabsorbents also shows that the pneumatic conveying process creates more undesirable finer particles than the inventive process. The product conveyed by the inventive fraction processes more closely resembles the product before conveying than that transported by the pneumatic process, resulting in a higher performing, less dusty final product.

TABLE 1

| | | | | GBP | PSD (%) | | | | | | | |
|---|---|---|---|---|---|---|---|---|---|---|---|---|
| | | CRC | AAP | (×10⁻⁸ | 20 | 30 | 50 | 100 | 140 | 170 | 325 | |
| | | (g/g) | (g/g) | cm2) | mesh | mesh | mesh | mesh | mesh | mesh | mesh | pan |
| Product | — | 27.3 | 24.7 | 19.8 | 0.03 | 6.61 | 69.44 | 21.89 | 1.23 | 0.27 | 0.37 | 0.17 |
| A | air conveyed | 27.4 | 15.3 | 7.2 | 0 | 0.77 | 45.05 | 34.75 | 7.55 | 3.58 | 5.26 | 3.04 |
| | bucket conveyed | 27.2 | 24.5 | 18.0 | 0.03 | 5.94 | 68.22 | 23.92 | 1.28 | 0.24 | 0.3 | 0.07 |
| Product | — | 26.2 | 25.0 | 17.1 | 0.27 | 3.4 | 61.64 | 28.53 | 4.57 | 0.69 | 0.66 | 0.25 |
| B | air conveyed | 27.5 | 13.8 | 8.1 | 0.22 | 1 | 48.67 | 32.1 | 7.2 | 3.36 | 4.66 | 2.79 |
| | bucket conveyed | 27.7 | 24.7 | 17.9 | 0.74 | 5.42 | 69.28 | 20.89 | 2.64 | 0.4 | 0.42 | 0.2 |
| Product | — | 32.3 | 16.8 | 36.4 | 1.58 | 25.44 | 54.11 | 16.69 | 1.64 | 0.15 | 0.29 | 0.1 |
| C | air conveyed | 36 | 12.5 | 9.5 | 0.5 | 17.45 | 50.5 | 20.75 | 4.12 | 1.93 | 2.86 | 1.89 |
| | chain conveyed | 34.7 | 15.5 | 36.1 | 0.99 | 24.67 | 52.83 | 18.98 | 1.94 | 0.19 | 0.23 | 0.18 |
| Product | — | 32.8 | 18.4 | 36.8 | 1.14 | 21.86 | 50.29 | 22.59 | 2.86 | 0.48 | 0.52 | 0.27 |
| D | air conveyed | 34.4 | 11.4 | 10.5 | 0.28 | 13.11 | 47.89 | 26.08 | 5.33 | 2.17 | 3.18 | 1.96 |
| | chain conveyed | 34.3 | 17.5 | 33.5 | 1.32 | 24.6 | 53.29 | 18.26 | 1.88 | 0.26 | 0.25 | 0.15 |

1. A process for producing water-absorbing polymer particles, comprising
(i) the polymerization of a monomer solution or suspension comprising
a) at least one ethylenically unsaturated monomer which bears acid groups and may have been at least partly neutralized,
b) at least one crosslinker,
c) at least one initiator,
d) optionally one or more ethylenically unsaturated monomers copolymerizable with the monomers mentioned in a) and
e) optionally one or more water-soluble polymers,
in order to forma water-insoluble polymer gel,
(ii) optionally comminuting the polymer gel,
(iia) optionally breaking up the polymer gel in a breakup unit which is preferably a rotating drum,
(iii) drying the polymer gel,
(iv) grinding the polymer gel to polymer particles,
(v) classifying the polymer particles,
(vi) surface postcrosslinking the classified polymer particles,
(vii) cooling and optionally after treating the surface crosslinked polymer particles,
the process comprising conveying steps for the particulate material that arises, characterized in that a conveying machine from the group of the mechanical continuous conveyors with traction mechanism is used in at least one of the conveying steps.

2. The process for producing water-absorbing polymer particles according to claim 1, wherein the conveying machines selected from the group of the mechanical continuous conveyors with traction mechanism are used in at least one of the conveying steps (a) and (b), where the conveying step (a) precedes the surface postcrosslinking step (vi) and the conveying step (b) follows the surface postcrosslinking step (vi).

3. The process according to claim 1, wherein the conveying machines selected from the group of the mechanical continuous conveyors with traction mechanism are used in the conveying step (c), where the conveying step (c) relates to the transport of the finished superabsorbent end product, into the end product silos or silo vehicles.

4. The process according to claim 2, wherein at least conveying step (b), are effected using conveying machines from the group of the mechanical continuous conveyors with traction mechanism.

5. The process according to claim 1, wherein the conveying machines used are tubular drag conveyors and/or bucket conveyors.

6. The process according to claim 1, wherein a screw conveyor is additionally used at least in one of the conveying steps.

7. The process according to claim 1, wherein a blowing agent is used in the polymerization of the monomer solution or suspension, such that a foamed water-insoluble polymer gel is formed.

8. The process according to claim 1, wherein the blowing agent used is a gas, such as CO₂ in particular, or a compound having ability to release gas, such as carbonate salts in particular.

9. The process according to claim 1, wherein the monomer solution or suspension comprises at least one surfactant, preferably an ethylenically unsaturated surfactant.

10. The process according to claim 9 wherein the surfactant is present in the monomer solution or suspension in an amount of 0.01% to 5% by weight.

11. The process according to claim 1, wherein the monomer a) is acrylic acid, and in that a compound which can form covalent bonds with at least two acid groups of the polymer particles is used for surface postcrosslinking in step vi), and in that the polymer particles are coated after step v.

12. A water-absorbing polymer particles obtainable by a process according to claim 1.

13. The water-absorbing polymer particles according to claim 12, having
(a) a centrifuge retention capacity (CRC) of at least 24 g/g,
(b) a free swell rate (FSR) of at least 0.15 g/gs,
(c) a permeability (SFC) of at least 50×10⁻⁷ cm³ s/g,
(d) an absorbency against a pressure of 4.83 kPa of at least 15 g/g,
(e) a surface tension preferably exceeding 50 mN/m.

14. (canceled)

15. (canceled)

16. Foams, moldings, fibers, foils, films, cables, sealing materials, liquid-absorbing hygiene articles, carriers for plant growth and fungal growth regulators, packaging materials, soil additives or building materials, including water-absorbing polymer particles according to claim 1.
